(19) United States
(12) Patent Application Publication
(10) Pub. No.: US 2025/0188393 A1
(43) Pub. Date: Jun. 12, 2025

(54) BEER-FLAVORED BEVERAGE

(71) Applicant: SUNTORY HOLDINGS LIMITED, Osaka-shi, Osaka (JP)

(72) Inventor: Yuichi Kato, Fuchu-shi (JP)

(73) Assignee: SUNTORY HOLDINGS LIMITED, Osaka-shi, Osaka (JP)

(21) Appl. No.: 18/846,002

(22) PCT Filed: Mar. 28, 2023
(86) PCT No.: PCT/JP2023/012380

§ 371 Date: Sep. 11, 2024

(30) Foreign Application Priority Data
Mar. 31, 2022 (JP) 2022-058107

(51) Int. Cl. C12C 12/04; A23L 2/68

(52) U.S. Cl. CPC C12C 12/04; A23L 2/68

(57) ABSTRACT

A beer-flavored beverage having an alcohol percentage of 1.0-3.8 (v/v) % and a pyroglutamic acid content of 60 mg/L or more.

### TECHNICAL FIELD

The present invention relates to a beer-taste beverage.

### BACKGROUND ART

Various beer-taste beverages have been studied and provided in response to recent diversified preferences of consumers.

For example, Patent Document 1 discloses a beer-taste beverage containing predetermined amounts of proline and amino nitrogen and having an alcohol concentration of less than 1% (v/v).

### CITATION LIST

### Patent Document

Patent Document 1: JP 2021-180688 A

### SUMMARY OF INVENTION

### Technical Problem

A beer-taste beverage having a low alcohol content tends to have an insufficient full bodied taste. Therefore, there is a demand for a low alcohol beer-taste beverage having a good full bodied taste.

### Solution to Problem

The present invention provides a low alcohol content beer-taste beverage having a content of pyroglutamic acid adjusted to a predetermined range.

That is, the present invention includes the following embodiments.

[1]

A beer-taste beverage having:
an alcohol content of 1.0 (v/v) % or more and 3.8 (v/v) % or less, and
a content of pyroglutamic acid of 60 mg/L or more.

[2]

The beer-taste beverage according to [1], wherein a malt ratio is 50 mass % or more.

[3]

The beer-taste beverage according to [1] or [2], wherein an apparent attenuation is less than 100%.

[4]

The beer-taste beverage according to any one of [1] to [3], wherein a content of isoamyl alcohol is more than 20 mg/L and 190 mg/L or less.

[5]

The beer-taste beverage according to any one of [1] to [4], further containing at least one acidulant selected from the group consisting of phosphoric acid, citric acid, malic acid, succinic acid, lactic acid, and acetic acid.

[6]

The beer-taste beverage according to [5], wherein a ratio [(B)/(A)] of a content (B) (unit: mg/L) of the acidulant to the alcohol content (A) (unit: v/v %) is 550 or less.

[7]

The beer-taste beverage according to [5] or [6], wherein the content (B) of the acidulant is from 500 to 2000 mg/L.

[7A]

The beer-taste beverage according to [5] or [6], wherein the content (B) of the acidulant is from 300 to 2000 mg/L.

[8]

The beer-taste beverage according to any one of [5] to [7], wherein the content of the at least one acidulant selected from the group consisting of phosphoric acid, citric acid, malic acid, succinic acid, lactic acid, and acetic acid satisfies at least one of the following:
a content of phosphoric acid: from 300 to 1200 mg/L;
a content of citric acid: from 100 to 900 mg/L;
a content of malic acid: from 40 to 800 mg/L;
a content of succinic acid: from 10 to 700 mg/L,
a content of lactic acid: from 100 to 1000 mg/L; and
a content of acetic acid: from 10 to 100 mg/L.

[8A]

The beer-taste beverage according to any one of [5] to [7A], wherein the content of the at least one acidulant selected from the group consisting of phosphoric acid, citric acid, malic acid, succinic acid, lactic acid, and acetic acid satisfies at least one of the following:
a content of phosphoric acid: from 100 to 1200 mg/L;
a content of citric acid: from 50 to 900 mg/L;
a content of malic acid: from 20 to 800 mg/L;
a content of succinic acid: from 10 to 700 mg/L,
a content of lactic acid: from 50 to 1000 mg/L; and
a content of acetic acid: from 10 to 100 mg/L.

[9]

The beer-taste beverage according to any one of [1] to [8], wherein the alcohol content is 1.5 (v/v) % or more and 3.3 (v/v) % or less.

[10]

The beer-taste beverage according to any one of [1] to [9], wherein a carbohydrate content is 1.0 g/100 mL or more.

[11]

The beer-taste beverage according to any one of [1] to [10], wherein the carbohydrate content is 2.0 g/100 mL or more.

[12]

A method for producing a beer-taste beverage, the method including adjusting
an alcohol content to 1.0 (v/v) % or more and 3.8 (v/v) % or less and
a content of pyroglutamic acid to 60 mg/L or more.

[13]

A method for improving flavor of a beer-taste beverage, the method including adjusting
an alcohol content to 1.0 (v/v) % or more and 3.8 (v/v) % or less and
a content of pyroglutamic acid to 60 mg/L or more.

### Advantageous Effects of Invention

Further, according to a preferred embodiment of the present invention, a beer-taste beverage having a suitable full bodied taste is provided. In addition, according to a preferred embodiment of the present invention, a beer-taste beverage having a reduced ethanol feeling unsuitable for low alcohol beer-taste beverages is provided. Further, according to a preferred embodiment of the present invention, a beer-taste beverage having a suitable aftertaste is provided. Further, according to a preferred embodiment of the present invention, a beer-taste beverage having a reduced unsuitable solvent odor is provided. Further, according to a preferred embodiment of the present invention, a beer-taste beverage having a suitable refreshing aftertaste is provided. In addition, according to a preferred embodiment of the present invention, a beer-taste beverage having a reduced unsuitable sourness is provided.

### DESCRIPTION OF EMBODIMENTS

For numerical ranges described herein, upper and lower limits can be arbitrarily combined. For example, the numerical range of “preferably from 3.0 to 15, and more preferably from 3.2 to 13” described herein includes also a range of “from 3.0 to 13” and a range of “from 3.2 to 15”. In addition, for example, the numerical range of “preferably 30 or more, and more preferably 40 or more, and preferably 100 or less, and more preferably 80 or less” described herein includes also a range of “from 30 to 80” and a range of “from 40 to 100”.

In addition, for example, the numerical range of “from 60 to 100” described herein means a range of “60 or more (60 or more than 60) and 100 or less (100 or less than 100)”.

Furthermore, in the definitions of the upper limit values and the lower limit values described herein, numerical ranges of from lower limit values to upper limit values can be defined by appropriately selecting numerical values from among respective options and arbitrarily combining them.

In addition, a plurality of various requirements described as preferred embodiments described herein can be combined.

### 1. Beer-Taste Beverage

The “beer-taste beverage” herein refers to an alcohol-containing carbonated beverage with a beer-like flavor. That is, unless otherwise specified, the beer-taste beverage herein includes any carbonated beverage having a beer flavor.

Therefore, the “beer-taste beverage” includes not only beers, which are malt-fermented beverages produced by fermenting malts, hops, and water as raw materials with yeasts, and fermented beer-taste beverages, but also carbonated beverages added with a beer flavoring including esters, higher alcohols and lactones, and additionally low-malt beer and effervescent liqueurs called under the Japanese Liquor Tax Law. The beer-taste beverage according to one embodiment of the present invention is beer.

Examples of the beer flavoring include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineol, 1,8-cineol, 2,3-diethyl-5-methylpyrazine, γ-decanolactone, γ-undecalactone, ethyl hexanoate, ethyl 2-methylbutyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranyl acetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3(2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-buten-1-one, trans-2-hexenal, nonanal, and phenethyl alcohol.

In addition, the beer-taste beverage according to an embodiment of the present invention may be a fermented beer-taste beverage that has undergone a fermentation step using a yeast, or may be a non-fermented beer-taste beverage that has not undergone a fermentation step.

The fermented beer-taste beverage may be an ale beer-taste beverage brewed through a fermentation step using a top-fermenting yeast (e.g., Saccharomyces), a lager beer-taste beverage brewed through a fermentation step using a bottom-fermenting yeast (e.g., Saccharomyces), or a pilsner beer-taste beverage, or may be a beer-taste beverage produced by blending these beer-taste beverages. Furthermore, the fermented beer-taste beverage may be produced from a beer-taste stock solution blend of a beer-taste stock solution brewed through a fermentation step using a top-fermenting yeast (for example, a solution at a stage before being provided as a beverage, such as a fermented liquid after fermentation) and a beer-taste stock solution brewed through a fermentation step using a bottom-fermenting yeast.

The term “fermentation” as used herein may be alcoholic fermentation in which an alcohol is produced or non-alcoholic fermentation in which no alcohol is produced.

In addition, the beer-taste beverage according to an embodiment of the present invention may be a malt-based beer-taste beverage produced using malt as a raw material or may be a malt-free beer-taste beverage produced without using malt. Examples of the malt-based beer-taste beverage include barley malt-based beer-taste beverages.

The beer-taste beverage according to an embodiment of the present invention is a low alcohol beer-taste beverage. As used herein, the term “low alcohol” refers to a beer-taste beverage having an alcohol content (ethanol content) of 1.0 (v/v) % or more and 3.8 (v/v) % or less. The alcohol content of the beer-taste beverage according to an embodiment of the present invention is preferably 1.1 (v/v) % or more, 1.2 (v/v) % or more, 1.3 (v/v) % or more, 1.4 (v/v) % or more, or 1.5 (v/v) % or more, and, further, may be 1.6 (v/v) % or more, 1.7 (v/v) % or more, 1.8 (v/v) % or more, 1.9 (v/v) % or more, 2.0 (v/v) % or more, 2.1 (v/v) % or more, 2.2 (v/v) % or more, 2.3 (v/v) % or more, 2.4 (v/v) % or more, 2.5 (v/v) % or more, 2.6 (v/v) % or more, 2.7 (v/v) % or more, 2.8 (v/v) % or more, 2.9 (v/v) % or more, 3.0 (v/v) % or more, 3.1 (v/v) % or more, 3.2 (v/v) % or more, 3.3 (v/v) % or more, 3.4 (v/v) % or more, or 3.5 (v/v) % or more, from the viewpoint of providing a beer-taste beverage having a full bodied taste.

On the other hand, the alcohol content of the beer-taste beverage according to an embodiment of the present invention is preferably 3.8 (v/v) % or less, 3.7 (v/v) % or less, 3.6 (v/v) % or less, 3.5 (v/v) % or less, 3.4 (v/v) % or less, or 3.3 (v/v) % or less, and, further, may be 3.2 (v/v) % or less, 3.1 (v/v) % or less, 3.0 (v/v) % or less, 2.9 (v/v) % or less, 2.8 (v/v) % or less, 2.7 (v/v) % or less, 2.6 (v/v) % or less, 2.5 (v/v) % or less, 2.4 (v/v) % or less, 2.3 (v/v) % or less, 2.2 (v/v) % or less, 2.1 (v/v) % or less, or 2.0 (v/v) % or less, from the viewpoint of reducing the ethanol feeling unsuitable for low alcohol beer-taste beverages and improving quaffability.

The alcohol content herein is expressed by percentage on a volume/volume basis ((v/v) %). Also, the alcohol content of the beverage can be measured by any known method and can be measured, for example, with a vibrating densimeter.

The alcohol content can be adjusted by appropriately setting, for example, the addition of dilution water or carbonated water, the types of raw materials (such as malt, corn grits, or sugar solution), the amounts of raw materials, the type of enzyme, the amount of enzyme added, the timing for enzyme addition, the saccharification time in a preparation tank, the proteolysis time in a preparation tank, the pH in a preparation tank, the pH in a preparation step (wort production step from feeding of malt until before addition of yeast), the amount of acid added for pH adjustment, timing for pH adjustment (during preparation, during fermentation, at completion of fermentation, before beer filtration, after beer filtration, or the like), the set temperature and retention time in each temperature region in preparation of wort (including during saccharification), the original extract concentration of a pre-fermentation liquid, the original extract concentration in a fermentation step, the fermentation conditions (such as the oxygen concentration, aeration conditions, yeast variety, amount of yeast added, number of yeast grown, timing for removal of yeast, fermentation temperature, fermentation time, pressure setting, carbon dioxide concentration, amount of enzyme added, type of enzyme, and timing for enzyme addition), and the addition of spirits, brewed alcohol, or the like.

The beer-taste beverage according to one embodiment of the present invention may contain spirits (distilled alcoholic beverage) derived from grain as an alcohol component.

Here, the “spirits” means an alcoholic beverage produced by saccharifying grain, such as barley/wheat, rice, buckwheat, corn, potato, or sugar cane as a raw material using malt or, as necessary, an enzymatic agent, fermenting the saccharified product using yeast, and then distilling the fermented product. As the grain which is a raw material for the spirits, a plant belonging to the family Gramineae is preferable, and barley/wheat is more preferable.

When the beer-taste beverage of the present invention is a fermented beer-taste beverage, an apparent attenuation is preferably less than 100%. A beer-taste beverage having a high apparent attenuation can suppress satiety, but tends to have a decreased full bodied taste. Therefore, in the case where the beer-taste beverage according to an embodiment of the present invention is a fermented beer-taste beverage, saccharification conditions and fermentation conditions are adjusted so that the apparent attenuation is less than 100%, thereby making it possible to provide a beer-taste beverage which has a full bodied taste even with a low alcohol content and further enhances a rich taste derived from barley/wheat.

In the case where the beer-taste beverage according to an embodiment of the present invention is a fermented beer-taste beverage, the apparent attenuation is less than 100% from the above viewpoint, but is preferably 99% or less, more preferably 98% or less, even more preferably 97% or less, still more preferably 96% or less, and particularly preferably 95% or less, and may be 94% or less, 93% or less, 92% or less, 91% or less, 90% or less, 89% or less, 88% or less, 87% or less, 86% or less, 85% or less, 84% or less, 83% or less, 82% or less, 81% or less, 80% or less, 79% or less, 78% or less, 77% or less, 76% or less, 75% or less, 74% or less, 73% or less, 72% or less, 71% or less, or 70% or less.

On the other hand, in the case where the beer-taste beverage of an embodiment of the present invention is a fermented beer-taste beverage, the apparent attenuation is 5% or more, preferably 6% or more, more preferably 7% or more, even more preferably 8% or more, still more preferably 9% or more, and particularly preferably 10% or more, and may be 11% or more, 12% or more, 13% or more, 14% or more, 15% or more, 16% or more, 17% or more, 18% or more, 19% or more, 20% or more, 21% or more, 22% or more, 23% or more, 24% or more, 25% or more, 26% or more, 27% or more, 28% or more, 29% or more, 30% or more, 31% or more, 32% or more, 33% or more, 34% or more, 35% or more, 36% or more, 37% or more, 38% or more, 39% or more, 40% or more, 41% or more, 42% or more, 43% or more, 44% or more, 45% or more, 46% or more, 47% or more, 48% or more, 49% or more, 50% or more, 51% or more, 52% or more, 53% or more, 54% or more, 55% or more, 56% or more, 57% or more, 58% or more, 59% or more, 60% or more, 61% or more, 62% or more, 63% or more, 64% or more, or 65% or more, from the viewpoint of providing a beer-taste beverage having a suppressed unsuitable satiety.

As used herein, the term “apparent attenuation” refers to a proportion of a concentration of a sugar that can be consumed by yeast as a nutrient source for alcoholic fermentation to a total concentration of sugars contained in a liquid before fermentation. For example, the apparent attenuation AA of the beer-taste beverage of the present invention can be calculated from the following equation (1).

$$AA ( \% ) = 100 \times ( P - Es ) / P \qquad Equation ( 1 )$$

In the above equation (1), “P” represents an original extract (original wort extract) and can be measured by a method described in “BCOJ Beer Analysis Method (published by The Brewing Society of Japan, edited by Brewers Association of Japan, revised on Nov. 1, 2004)”.

“Es” represents an apparent extract of the beer-taste beverage. The apparent extract can be calculated from the following equation (2), as described in, for example, “BCOJ Beer Analysis Method (published by The Brewing Society of Japan, edited by Brewers Association of Japan, revised on Nov. 1, 2004)”.

$$Es = - 460.234 + 662.649 \times D - 202.414 \times {D}^{2} \qquad Equation ( 2 )$$

where D is a specific gravity of a degassed beer-taste beverage.

Since the apparent extract “Es” may have a negative value depending on D in the above equation (2), the calculated apparent attenuation may exceed 100%.

The apparent attenuation of the beer-taste beverage can be adjusted by appropriately setting, for example, the addition of dilution water or carbonated water, the types of raw materials (such as malt, corn grits, and sugar solution), the amounts of raw materials, the type of enzyme, the amount of enzyme added (also including a saccharolytic enzyme or an isomerase), the temperature in enzymatic reaction, the timing of enzyme addition, the saccharification time, the pH during saccharification, the temperature during saccharification, the pH in the preparation step (wort production step from feeding of malt until before addition of yeast), the temperature in the preparation step, the time for wort filtration, the set temperature and retention time in each temperature region in preparation of wort (including during saccharification), the original extract concentration in the pre-fermentation liquid, the original extract concentration in the fermentation step, the fermentation conditions (such as the oxygen concentration, aeration conditions, yeast variety, amount of yeast added, the number of yeast grown, removal timing of yeast, fermentation temperature, fermentation time, pressure setting, carbon dioxide concentration, amount of enzyme added, type of enzyme, and timing for enzyme addition), the cooling timing, the cooling temperature, and the cooling time.

When the alcohol content of the beer-taste beverage is 3.8 (v/v) % or less, there is a tendency that the full bodied taste is insufficient. However, according to an embodiment of the present invention, the content of pyroglutamic acid is adjusted to be in a predetermined range, and thus, even when the alcohol content is relatively low as described above, a good full bodied taste can be imparted to the beer-taste beverage. Pyroglutamic acid is one of organic acids contained in malt and the like, and is a compound having no amino group (—NH₂) in its structure as represented by the following formula.

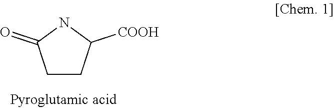

From the above viewpoint, the content of pyroglutamic acid in the beer-taste beverage of an embodiment of the present invention is preferably 60 mg/L or more, more preferably 65 mg/L or more, even more preferably 70 mg/L or more, still more preferably 75 mg/L or more, further more preferably 80 mg/L or more, further more preferably 85 mg/L or more, further more preferably 90 mg/L or more, further more preferably 95 mg/L or more, and particularly preferably 100 mg/L or more, and may be 110 mg/L or more, 115 mg/L or more, 120 mg/L or more, 125 mg/L or more, 130 mg/L or more, 135 mg/L or more, 140 mg/L or more, 145 mg/L or more, or 150 mg/L or more.

On the other hand, from the viewpoint of providing a beer-taste beverage having a well-balanced flavor, the content of pyroglutamic acid may be 600 mg/L or less, 590 mg/L or less, 580 mg/L or less, 570 mg/L or less, 560 mg/L or less, 550 mg/L or less, 540 mg/L or less, 530 mg/L or less, 520 mg/L or less, 510 mg/L or less, 500 mg/L or less, 490 mg/L or less, 480 mg/L or less, 470 mg/L or less, or 460 mg/L or less.

The pyroglutamic acid may be contained in a raw material for the beer-taste beverage or may be separately added in a production process (for example, a pyroglutamic acid purified product).

The content of pyroglutamic acid can be adjusted by appropriately setting, for example, the addition of dilution water or carbonated water, the addition of a pyroglutamic acid purified product, type of the pyroglutamic acid-containing raw material (such as malt, barley/wheat, corn grits, sugar solution, yeast extract, soybean, pea, or pyroglutamic acid purified product), the amount of raw materials, the enzyme reaction time in a preparation step (wort production step from feeding of a raw material such as malt until before addition of yeast), the pH in a preparation step, the added amount of acid used in pH adjustment, timing for pH adjustment (during preparation, during fermentation, at completion of fermentation, before beer filtration, after beer filtration, or the like), the set temperature and retention time in each temperature region in preparation of wort (including during saccharification), the original extract concentration of a pre-fermentation liquid, the original extract concentration in a fermentation step, the fermentation conditions (such as the oxygen concentration, aeration conditions, yeast variety, amount of yeast added, number of yeast grown, timing for removal of yeast, fermentation temperature, fermentation time, pressure setting, and carbon dioxide concentration), and the addition of spirits, brewed alcohol, or the like.

The content of pyroglutamic acid herein can be measured, for example, by high-performance liquid chromatography.

In the beer-taste beverage of an embodiment of the present invention, a product [(A)×(C)] of the alcohol content (A) (unit: v/v %) and the content of pyroglutamic acid (C) (unit: mg/L) is preferably 100 or more, more preferably 150 or more, even more preferably 200 or more, still more preferably 250 or more, further more preferably 300 or more, further more preferably 350 or more, further more preferably 400 or more, further more preferably 450 or more, further more preferably 500 or more, and particularly preferably 550 or more, and may be 600 or more, 650 or more, 700 or more, 750 or more, 800 or more, 850 or more, 900 or more, 950 or more, or 1000 or more, from the viewpoint of improving the full bodied taste.

On the other hand, the product [(A)×(C)] of the alcohol content (A) (unit: v/v %) and the content of pyroglutamic acid (C) (unit: mg/L) is preferably 2000 or less, more preferably 1900 or less, even more preferably 1800 or less, still more preferably 1700 or less, and particularly preferably 1600 or less, and may be 1590 or less, 1570 or less, 1550 or less, 1500 or less, 1450 or less, 1400 or less, 1350 or less, 1300 or less, 1250 or less, 1200 or less, 1150 or less, 1100 or less, 1050 or less, or 1000 or less, from the viewpoint of providing a beer-taste beverage having a light taste.

The beer-taste beverage according to an embodiment of the present invention preferably further contains isoamyl alcohol. The isoamyl alcohol is one of aroma components exhibiting a brewing aroma. According to an embodiment of the present invention, the content of pyroglutamic acid is adjusted to be in the above-described range and isoamyl alcohol is further blended, thereby making it possible to impart a suitable aftertaste to the beer-taste beverage.

From the above viewpoint, the content of isoamyl alcohol in the beer-taste beverage according to an embodiment of the present invention is preferably more than 20 mg/L, more preferably 21 mg/L or more, even more preferably 22 mg/L or more, still more preferably 23 mg/L or more, further more preferably 24 mg/L or more, further more preferably 25 mg/L or more, further more preferably 26 mg/L or more, further more preferably 27 mg/L or more, and particularly preferably 28 mg/L or more, and may be 29 mg/L or more, 30 mg/L or more, 31 mg/L or more, 32 mg/L or more, 33 mg/L or more, 34 mg/L or more, 35 mg/L or more, 36 mg/L or more, 37 mg/L or more, 38 mg/L or more, 39 mg/L or more, or 40 mg/L or more.

On the other hand, the content of isoamyl alcohol in the beer-taste beverage according to an embodiment of the present invention is preferably 190 mg/L or less, more preferably 185 mg/L or less, more preferably 180 mg/L or less, even more preferably 175 mg/L or less, still more preferably 170 mg/L or less, further more preferably 165 mg/L or less, further more preferably 160 mg/L or less, further more preferably 155 mg/L or less, further more preferably 150 mg/L or less, further more preferably 145 mg/L or less, further more preferably 140 mg/L or less, further more preferably 135 mg/L or less, further more preferably 130 mg/L or less, further more preferably 125 mg/L or less, further more preferably 120 mg/L or less, further more preferably 119 mg/L or less, further more preferably 118 mg/L or less, further more preferably 117 mg/L or less, further more preferably 116 mg/L or less, further more preferably 115 mg/L or less, further more preferably 114 mg/L or less, further more preferably 113 mg/L or less, further more preferably 112 mg/L or less, further more preferably 111 mg/L or less, or further more preferably 110 mg/L or less, from the viewpoint of reducing the solvent odor unsuitable for beer-taste beverages.

In the beer-taste beverage according to an embodiment of the present invention, a product [(A)×(D)] of the alcohol content (A) (unit: v/v %) and the content (D) (unit: mg/L) of isoamyl alcohol is preferably 50 or more, more preferably 51 or more, and even more preferably 52 or more, and may be 55 or more, 60 or more, 65 or more, 70 or more, 75 or more, 80 or more, 85 or more, 90 or more, 95 or more, 100 or more, 110 or more, 120 or more, 130 or more, 140 or more, or 150 or more, from the viewpoint of imparting a suitable aftertaste typical of beer-taste beverages.

On the other hand, the product [(A)×(D)] of the alcohol content (A) (unit: v/v %) and the content (D) (unit: mg/L) of isoamyl alcohol is preferably 450 or less, more preferably 400 or less, even more preferably 390 or less, still more preferably 380 or less, further more preferably 370 or less, and particularly preferably 360 or less, and may be 350 or less, 340 or less, 330 or less, 320 or less, 310 or less, 300 or less, 280 or less, 260 or less, or 240 or less, from the viewpoint of reducing an unsuitable solvent odor and providing an quaffable beverage.

The isoamyl alcohol may be contained in raw materials for the beer-taste beverage or may be a purified product to be separately added as a flavoring in a production process.

The content of isoamyl alcohol can be adjusted by appropriately setting, for example, the addition of dilution water or carbonated water, the addition of the purified product, the type of isoamyl alcohol-containing raw material (such as hop), the amount of the raw material, and the timing for addition of the raw material.

The content of isoamyl alcohol can be measured by headspace gas chromatography equipped with an FID detector in accordance with a method described in the item “8.22 Low Boiling Point Aroma Components” of Revised BCOJ Beer Analysis Method (Enlarged and Revised Edition of 2013), which is an analysis method defined by Brewery Convention of Japan (BCOJ), Brewers Association of Japan.

The beer-taste beverage according to an embodiment of the present invention further contains at least one acidulant selected from the group consisting of phosphoric acid, citric acid, malic acid, succinic acid, lactic acid, and acetic acid. The beer-taste beverage according to another embodiment of the present invention may contain all acidulants including phosphoric acid, citric acid, malic acid, succinic acid, lactic acid, and acetic acid. These acidulants are not limited to acidulants approved as food additives, and may be those originating from raw materials such as malt, those produced by adjustment of various process conditions, those produced by yeast, and those externally added as additives.

A ratio [(B)/(A)] of a content (B) (unit: mg/L) of the acidulant to the alcohol content (A) (unit: v/v %) is adjusted to be within a predetermined range, and thus the beer-taste beverage of an embodiment of the present invention can be a beer-taste beverage having a refreshing aftertaste with a harmonized ethanol feeling and sourness.

From the above viewpoint, the ratio [(B)/(A)] of the content (B) (unit: mg/L) of the acidulant to the alcohol content (A) (unit: v/v %) is preferably 550 or less, more preferably 545 or less, even more preferably 540 or less, and particularly preferably 535 or less, and may be 530 or less, 525 or less, 520 or less, 515 or less, 510 or less, 505 or less, 500 or less, 495 or less, 490 or less, 485 or less, 480 or less, 475 or less, 470 or less, 465 or less, 460 or less, 455 or less, or 450 or less.

On the other hand, from the viewpoint of reducing the sourness unsuitable for beer-taste beverages, the ratio [(B)/(A)] of the content (B) (unit: mg/L) of the acidulant to the alcohol content (A) (unit: v/v %) is preferably 300 or more, more preferably 310 or more, even more preferably 320 or more, still further preferably 330 or more, and particularly preferably 340 or more, and may be 345 or more, 350 or more, 355 or more, 360 or more, 365 or more, 370 or more, 375 or more, 380 or more, 385 or more, 390 or more, 395 or more, or 400 or more.

In the beer-taste beverage according to an embodiment of the present invention, the content of at least one acidulant selected from the group consisting of phosphoric acid, citric acid, malic acid, succinic acid, lactic acid, and acetic acid is from 500 to 2000 mg/L. In the beer-taste beverage according to another embodiment of the present invention, a total content of all acidulants including phosphoric acid, citric acid, malic acid, succinic acid, lactic acid, and acetic acid may be from 500 to 2000 mg/L. Also, in the beer-taste beverage according to an embodiment of the present invention, the content of at least one acidulant selected from the group consisting of phosphoric acid, citric acid, malic acid, succinic acid, lactic acid, and acetic acid is from 300 to 2000 mg/L. In the beer-taste beverage according to another embodiment of the present invention, the total content of all acidulants including phosphoric acid, citric acid, malic acid, succinic acid, lactic acid, and acetic acid may be from 300 to 2000 mg/L.

In the beer-taste beverage according to an embodiment of the present invention, the content of the acidulant is preferably 500 mg/L or more, more preferably 550 mg/L or more, even more preferably 600 mg/L or more, still more preferably 650 mg/L or more, further more preferably 700 mg/L or more, further more preferably 750 mg/L or more, further more preferably 800 mg/L or more, further more preferably 850 mg/L or more, and particularly preferably 900 mg/L or more, and may be 950 mg/L or more, 1000 mg/L or more, 1050 mg/L or more, 1100 mg/L or more, 1150 mg/L or more, 1200 mg/L or more, 1250 mg/L or more, or 1300 mg/L or more, from the viewpoint of imparting a refreshing aftertaste to the beer-taste beverage.

In an embodiment, the content of the acidulant is also preferably 300 mg/L or more, 325 mg/L or more, 350 mg/L or more, 375 mg/L or more, 400 mg/L or more, 425 mg/L or more, or 450 mg/L or more.

On the other hand, the content of the acidulant is preferably 2000 mg/L or less, more preferably 1950 mg/L or less, even more preferably 1900 mg/L or less, and particularly preferably 1850 mg/L or less, or may be 1800 mg/L or less, 1750 mg/L or less, 1700 mg/L or less, 1650 mg/L or less, 1600 mg/L or less, 1550 mg/L or less, 1500 mg/L or less, 1450 mg/L or less, 1400 mg/L or less, 1350 mg/L or less, or 1300 mg/L or less, from the viewpoint of reducing the sourness unsuitable for beer-taste beverages.

The contents of the respective acidulants can be measured by a high-performance liquid chromatography (HPLC) method.

The beer-taste beverage according to an embodiment of the present invention contains at least one acidulant selected from the group consisting of phosphoric acid, citric acid, malic acid, succinic acid, lactic acid, and acetic acid, and the contents of the respective acidulants in the embodiment may be: a content of phosphoric acid of from 300 to 1200 mg/L, a content of citric acid of from 100 to 900 mg/L, a content of malic acid of from 40 to 800 mg/L, a content of succinic acid of from 10 to 700 mg/L, a content of lactic acid of from 100 to 1000 mg/L, and a content of acetic acid of from 10 to 100 mg/L. The content of the acidulant in the beer-taste beverage of the embodiment may satisfy at least one of the above contents. The beer-taste beverage according to another embodiment of the present invention contains an acidulant including phosphoric acid, citric acid, malic acid, succinic acid, lactic acid, and acetic acid. In the embodiment, the content of phosphoric acid constituting the acidulant may be from 300 to 1200 mg/L, the content of citric acid constituting the acidulant is from 100 to 900 mg/L, a content of malic acid constituting the acidulant may be from 40 to 800 mg/L, the content of succinic acid constituting the acidulant may be from 10 to 700 mg/L, the content of lactic acid constituting the acidulant may be from 100 to 1000 mg/L, and the content of acetic acid constituting the acidulant may be from 10 to 100 mg/L.

In each embodiment, the contents of phosphoric acid, citric acid, malic acid, succinic acid, lactic acid, and acetic acid may be in the following ranges.

The beer-taste beverage according to still another embodiment of the present invention contains at least one acidulant selected from the group consisting of phosphoric acid, citric acid, malic acid, succinic acid, lactic acid, and acetic acid, and the contents of the respective acidulants in the embodiment may be: a content of phosphoric acid of from 100 to 1200 mg/L, a content of citric acid of from 50 to 900 mg/L, a content of malic acid of from 20 to 800 mg/L, a content of succinic acid of from 10 to 700 mg/L, a content of lactic acid of from 50 to 1000 mg/L, and a content of acetic acid of from 10 to 100 mg/L. The content of the acidulant in the beer-taste beverage of the embodiment may satisfy at least one of the above contents. The beer-taste beverage according to still another embodiment of the present invention contains an acidulant including phosphoric acid, citric acid, malic acid, succinic acid, lactic acid, and acetic acid. In the embodiment, the content of phosphoric acid constituting the acidulant may be from 100 to 1200 mg/L, the content of citric acid constituting the acidulant is from 50 to 900 mg/L, a content of malic acid constituting the acidulant may be from 20 to 800 mg/L, the content of succinic acid constituting the acidulant may be from 10 to 700 mg/L, the content of lactic acid constituting the acidulant may be from 50 to 1000 mg/L, and the content of acetic acid constituting the acidulant may be from 10 to 100 mg/L.

That is, in the beer-taste beverage of an embodiment of the present invention, the content of phosphoric acid is preferably 300 mg/L or more, more preferably 310 mg/L or more, even more preferably 320 mg/L or more, still more preferably 330 mg/L or more, further more preferably 340 mg/L or more, and particularly preferably 350 mg/L or more, and may be 360 mg/L or more, 370 mg/L or more, 380 mg/L or more, 390 mg/L or more, 400 mg/L or more, 450 mg/L or more, 500 mg/L or more, 550 mg/L or more, 600 mg/L or more, 650 mg/L or more, or 700 mg/L or more, from the viewpoint of imparting a sharp taste suitable for beer-taste beverages. In addition, in an embodiment, the content of phosphoric acid is also preferably 100 mg/L or more, 125 mg/L or more, 150 mg/L or more, 175 mg/L or more, 200 mg/L or more, 225 mg/L or more, 250 mg/L or more, 275 mg/L or more, or 290 mg/L or more.

On the other hand, from the viewpoint of providing a beverage which is not too sour, the content of phosphoric acid is preferably 1200 mg/L or less, more preferably 1150 mg/L or less, even more preferably 1100 mg/L or less, still more preferably 1050 mg/L or less, and particularly preferably 1000 mg/L or less, and may be 950 mg/L or less, 900 mg/L or less, 850 mg/L or less, 800 mg/L or less, 750 mg/L or less, or 700 mg/L or less.

In the beer-taste beverage according to an embodiment of the present invention, the content of citric acid is preferably 100 mg/L or more, more preferably 110 mg/L or more, even more preferably 120 mg/L or more, still more preferably 130 mg/L or more, and particularly preferably 140 mg/L or more, and may be 150 mg/L or more, 160 mg/L or more, 170 mg/L or more, 180 mg/L or more, 185 mg/L or more, 190 mg/L or more, 200 mg/L or more, 210 mg/L or more, 220 mg/L or more, 230 mg/L or more, 240 mg/L or more, 250 mg/L or more, 260 mg/L or more, 270 mg/L or more, 280 mg/L or more, or 290 mg/L or more from the viewpoint of enhancing the umami taste of barley/wheat suitable for beer-taste beverages. In an embodiment, the content of citric acid is also preferably 50 mg/L or more, 55 mg/L or more, 60 mg/L or more, 65 mg/L or more, 70 mg/L or more, 75 mg/L or more, 80 mg/L or more, 85 mg/L or more, 90 mg/L or more, or 95 mg/L or more.

On the other hand, the content of citric acid is preferably 900 mg/L or less, more preferably 880 mg/L or less, even more preferably 860 mg/L or less, still more preferably 840 mg/L or less, further more preferably 820 mg/L or less, further more preferably 800 mg/L or less, and particularly preferably 780 mg/L or less, and may be 760 mg/L or less, 740 mg/L or less, 720 mg/L or less, 700 mg/L or less, 680 mg/L or less, 660 mg/L or less, or 650 mg/L or less, from the viewpoint of providing a beverage which is not too sour.

In the beer-taste beverage according to an embodiment of the present invention, the content of malic acid is preferably 40 mg/L or more, more preferably 45 mg/L or more, even more preferably 50 mg/L or more, still more preferably 55 mg/L or more, further more preferably 60 mg/L or more, further more preferably 65 mg/L or more, further more preferably 70 mg/L or more, and particularly preferably 75 mg/L or more, and may also be 80 mg/L or more, 85 mg/L or more, 90 mg/L or more, 95 mg/L or more, 100 mg/L or more, 105 mg/L or more, 110 mg/L or more, 120 mg/L or more, 140 mg/L or more, 160 mg/L or more, 180 mg/L or more, 200 mg/L or more, 220 mg/L or more, or 225 mg/L or more, from the viewpoint of enhancing the umami taste of barley/wheat suitable for beer-taste beverages. In an embodiment, the content of malic acid is also preferably 20 mg/L or more, 25 mg/L or more, 30 mg/L or more, or 35 mg/L or more.

On the other hand, from the viewpoint of providing a beverage which is not too sour, the content of malic acid is preferably 800 mg/L or less, more preferably 780 mg/L or less, even more preferably 760 mg/L or less, still more preferably 740 mg/L or less, further more preferably 720 mg/L or less, and particularly preferably 700 mg/L or less, and may be 695 mg/L or less, 680 mg/L or less, 660 mg/L or less, 640 mg/L or less, 620 mg/L or less, or 600 mg/L or less.

As the malic acid, synthetic malic acid may be used, fermented malic acid may be used, or synthetic malic acid and fermented malic acid may be used in combination.

In the beer-taste beverage according to an embodiment of the present invention, the content of succinic acid is preferably 10 mg/L or more, more preferably 15 mg/L or more, even more preferably 20 mg/L or more, still more preferably 25 mg/L or more, and particularly preferably 29 mg/L or more, and may be 30 mg/L or more, 35 mg/L or more, 40 mg/L or more, 60 mg/L or more, 80 mg/L or more, 100 mg/L or more, 120 mg/L or more, 140 mg/L or more, 160 mg/L or more, or 175 mg/L or more, from the viewpoint of enhancing the umami taste of barley/wheat suitable for beer-taste beverages.

On the other hand, from the viewpoint of providing a beverage which is not too sour, the content of succinic acid is 700 mg/L or less, more preferably 690 mg/L or less, even more preferably 680 mg/L or less, still more preferably 670 mg/L or less, further more preferably 660 mg/L or less, further more preferably 650 mg/L or less, and particularly preferably 640 mg/L or less, and may be 620 mg/L or less, 600 mg/L or less, 550 mg/L or less, 500 mg/L or less, or 450 mg/L or less.

On the other hand, in the beer-taste beverage according to an embodiment of the present invention, the content of lactic acid is preferably 100 mg/L or more, more preferably 120 mg/L or more, even more preferably 140 mg/L or more, still more preferably 160 mg/L or more, further more preferably 180 mg/L or more, further more preferably 200 mg/L or more, further more preferably 220 mg/L or more, further more preferably 240 mg/L or more, and particularly preferably 255 mg/L or more, and may be 260 mg/L or more, 280 mg/L or more, 300 mg/L or more, 320 mg/L or more, 340 mg/L or more, or 355 mg/L or more, from the viewpoint of imparting of mellowness suitable for beer-taste beverages. In an embodiment, the content of lactic acid is also preferably 50 mg/L or more, 55 mg/L or more, 60 mg/L or more, 65 mg/L or more, 70 mg/L or more, 75 mg/L or more, 80 mg/L or more, 85 mg/L or more, 90 mg/L or more, or 95 mg/L or more.

On the other hand, from the viewpoint of providing a beverage which is not too sour, the content of lactic acid is preferably 1000 mg/L or less, more preferably 980 mg/L or less, even more preferably 960 mg/L or less, still more preferably 940 mg/L or less, and particularly preferably 920 mg/L or less, and may be 900 mg/L or less, 880 mg/L or less, 860 mg/L or less, 840 mg/L or less, 820 mg/L or less, 800 mg/L or less, 750 mg/L or less, 700 mg/L or less, or 675 mg/L or less.

As the lactic acid, synthetic lactic acid may be used, fermented lactic acid may be used, or synthetic lactic acid and fermented lactic acid may be used in combination.

In the beer-taste beverage of an embodiment of the present invention, the content of acetic acid is preferably 10 mg/L, more preferably 15 mg/L or more, even more preferably 20 mg/L or more, still more preferably 25 mg/L or more, further more preferably 30 mg/L or more, further more preferably 35 mg/L or more, and particularly preferably 40 mg/L or more, and may be 45 mg/L or more, or 50 mg/L or more, from the viewpoint of imparting a sharp taste suitable for beer-taste beverages.

On the other hand, from the viewpoint of providing a beverage which is not too sour, the content of acetic acid is preferably 100 mg/L or less, more preferably 95 mg/L or less, even more preferably 90 mg/L or less, still more preferably 85 mg/L or less, further more preferably 80 mg/L or less, further more preferably 75 mg/L or less, further more preferably 70 mg/L or less, further more preferably 65 mg/L or less, and particularly preferably 60 mg/L or less, and may be 58 mg/L or less, 56 mg/L or less, 54 mg/L or less, 52 mg/L or less, or 50 mg/L or less.

From the viewpoint of providing a beverage having a full bodied taste, a carbohydrate content of the beer-taste beverage of an embodiment of the present invention may be 1.0 g/100 mL or more, 1.1 g/100 mL or more, 1.2 g/100 mL or more, 1.3 g/100 mL or more, 1.4 g/100 mL or more, 1.5 g/100 mL or more, 1.6 g/100 mL or more, 1.7 g/100 mL or more, 1.8 g/100 mL or more, 1.9 g/100 mL or more, 2.0 g/100 mL or more, 2.1 g/100 mL or more, 2.2 g/100 mL or more, 2.3 g/100 mL or more, 2.4 g/100 mL or more, 2.5 g/100 mL or more, 2.6 g/100 mL or more, 2.7 g/100 mL or more, 2.8 g/100 mL or more, 2.9 g/100 mL or more, 3.0 g/100 mL or more, 3.1 g/100 mL or more, 3.2 g/100 mL or more, 3.3 g/100 mL or more, 3.4 g/100 mL or more, 3.5 g/100 mL or more, 3.6 g/100 mL or more, 3.7 g/100 mL or more, 3.8 g/100 mL or more, 3.9 g/100 mL or more, 4.0 g/100 mL or more, 4.1 g/100 mL or more, 4.2 g/100 mL or more, 4.3 g/100 mL or more, 4.4 g/100 mL or more, or 4.5 g/100 mL or more.

From the viewpoint of providing a beverage which is hard to give satiety, the upper limit of the carbohydrate content of the beer-taste beverage according to an embodiment of the present invention is not particularly limited, and is, for example, 15 g/100 mL or less, 14 g/100 mL or less, 13.5 g/100 mL or less, 13 g/100 mL or less, 12.5 g/100 mL or less, 12 g/100 mL or less, 11.5 g/100 mL or less, 11 g/100 mL or less, 10.5 g/100 mL or less, 10 g/100 mL or less, 9.9 g/100 mL or less, 9.8 g/100 mL or less, 9.7 g/100 mL or less, 9.6 g/100 mL or less, 9.5 g/100 mL or less, 9.4 g/100 mL or less, 9.3 g/100 mL or less, 9.2 g/100 mL or less, 9.1 g/100 mL or less, 9.0 g/100 mL or less, 8.9 g/100 mL or less, 8.8 g/100 mL or less, 8.7 g/100 mL or less, 8.6 g/100 mL or less, 8.5 g/100 mL or less, 8.4 g/100 mL or less, 8.3 g/100 mL or less, 8.2 g/100 mL or less, 8.1 g/100 mL or less, 8.0 g/100 mL or less, 7.9 g/100 mL or less, 7.8 g/100 mL or less, 7.7 g/100 mL or less, 7.6 g/100 mL or less, 7.5 g/100 mL or less, 7.4 g/100 mL or less, 7.3 g/100 mL or less 7.2 g/100 mL or less, 7.1 g/100 mL or less, 7.0 g/100 mL or less, 6.9 g/100 mL or less, 6.8 g/100 mL or less, 6.7 g/100 mL or less, 6.6 g/100 mL or less, 6.5 g/100 mL or less, 6.4 g/100 mL or less, 6.3 g/100 mL or less, 6.2 g/100 mL or less, 6.1 g/100 mL or less, 6.0 g/100 mL or less, 5.9 g/100 mL or less, 5.8 g/100 mL or less, 5.7 g/100 mL or less, 5.6 g/100 mL or less, 5.5 g/100 mL or less, 5.4 g/100 mL or less, 5.3 g/100 mL or less, 5.2 g/100 mL or less, 5.1 g/100 mL or less, 5.0 g/100 mL or less, 4.9 g/100 mL or less, 4.8 g/100 mL or less, 4.7 g/100 mL or less, 4.6 g/100 mL or less, 4.5 g/100 mL or less, 4.4 g/100 mL or less, 4.3 g/100 mL or less, 4.2 g/100 mL or less, 4.1 g/100 mL or less, 4.0 g/100 mL or less, 3.9 g/100 mL or less, 3.8 g/100 mL or less, 3.7 g/100 mL or less, 3.6 g/100 mL or less, or 3.5 g/100 mL or less

The “carbohydrate” herein refers to a carbohydrate based on the Nutrition Labeling Standards for Foods (Ministry of Health, Labour and Welfare Notification No. 176, 2003, Consumer Affairs Agency Notification No. 8, Partial Revision, Sep. 27, 2013) and specifically means a material obtained by removing protein, lipid, dietary fiber, ash, alcohol content, and water from the target food. Thus, the carbohydrate content of a food can be calculated by subtracting the amounts of protein, lipid, dietary fiber, ash, and water from the weight of the food.

Here, the amounts of protein, lipid, dietary fiber, ash, and water can be measured by the methods described in the Nutrition Labeling Standards. Specifically, the amount of protein can be measured by a method of quantitative conversion of nitrogen, the amount of lipid can be measured by an ether extraction method, the amount of dietary fiber can be measured by the Prosky method, the amount of ash can be measured by a direct ashing method, and the amount of water can be measured by a method of heating and drying under reduced pressure.

The carbohydrate content of the beer-taste beverage according to an embodiment of the present invention can be adjusted by appropriately setting, for example, the addition of dilution water or carbonated water, the type of enzyme, the amount of enzyme added, and the timing for addition, the set temperature and retention time in each temperature region in preparation of a saccharified liquid, the composition of a pre-fermentation liquid (original extract concentration, sugar composition, protein content, dietary fiber content, ash content, and the like), various conditions for a fermentation step (oxygen concentration, aeration condition, yeast variety, amount of yeast added, number of yeast grown, timing for removal of yeast, fermentation temperature, fermentation time, pressure setting, carbon dioxide concentration, type of enzyme, amount of enzyme added, timing for enzyme addition, amount of enzyme added, type of enzyme, timing for enzyme addition, and the like), the cooling timing, the cooling temperature, and the cooling time.

The pH of the beer-taste beverage according to an embodiment of the present invention is not particularly limited, and is preferably 3.0 or more, more preferably 3.2 or more, even more preferably 3.3 or more, still more preferably 3.4 or more, and further more preferably 3.5 or more, and may be 3.6 or more, 3.7 or more, 3.8 or more, 3.9 or more, 4.0 or more, or 4.1 or more, from the viewpoint of improving flavor of the beverage. In addition, from the viewpoint of suppressing the generation of microorganisms, the pH of the beer-taste beverage is preferably 5.0 or less, more preferably 4.9 or less, even more preferably 4.8 or less, still more preferably 4.7 or less, and particularly preferably 4.6 or less, and may be 4.55 or less, 4.5 or less, 4.4 or less, 4.3 or less, 4.2 or less, 4.1 or less, or 4.0 or less.

The pH can be adjusted by appropriately setting, for example, the addition of dilution water or carbonated water, the types of raw materials (such as malt, corn grits, or sugar solution), the amounts of raw materials, the type of enzyme, the amount of enzyme added, the timing for enzyme addition, the saccharification time in a preparation tank, the proteolysis time in a preparation tank, the pH in a preparation tank, the pH in a preparation step (wort production step from feeding of malt until before addition of yeast), the type of acid used in pH adjustment (such as lactic acid, phosphoric acid, malic acid, tartaric acid, or citric acid), the added amount of acid used in pH adjustment, timing for pH adjustment (during preparation, during fermentation, at completion of fermentation, before beer filtration, after beer filtration, or the like), the set temperature and retention time in each temperature region in preparation of wort (including during saccharification), the original extract concentration of a pre-fermentation liquid, the original extract concentration in a fermentation step, the fermentation conditions (such as oxygen concentration, aeration conditions, yeast variety, amount of yeast added, number of yeast grown, timing for removal of yeast, fermentation temperature, fermentation time, pressure setting, and carbon dioxide concentration), the cooling timing, the cooling temperature, and the cooling time.

The beer-taste beverage according to an embodiment of the present invention is suitable for an embodiment of packaging. Examples of a container include a bottle, a PET bottle, a can, and a barrel. Particularly, a can, a bottle, and a PET bottle are preferable from the viewpoint of ease of carrying.

When a colorless and transparent bottle or PET bottle is used, the beer-taste beverage is exposed to sunlight or light from a fluorescent lamp, unlike the case where a normal can or a colored bottle is used.

Optional additive raw materials such as grains and sweeteners, which can be used in production of the beer-taste beverage of the present invention, will be described in detail in “1.1 Raw material”.

### 1.1 Raw Material

Main raw materials for the beer-taste beverage according to an embodiment of the present invention are water and malt, but hops are preferably used. In addition, a sweetener, a water-soluble dietary fiber, a bittering agent or bitterness imparting agent, an antioxidant, a flavoring, an acidulants, a salt, and the like may be used.

The malt refers to malt obtained by germinating seeds of barley and the like, such as barley, wheat, rye, wild oat, oat, adlay, or oat, drying the germinated seeds, and removing roots, and may be from any production area and of any variety.

In an embodiment of the present invention, the malt used is preferably barley malt. Barley malt is one of the malts most commonly used as a raw material for Japanese beer-taste beverages. There are several types of barley, such as two-rowed barley and six-rowed barley, and any of them may be used. Furthermore, in addition to ordinary malt, colored malt or the like can also be used. When colored malt is used, different types of colored malts may be appropriately used in combination, or one type of colored malt may be used.

The malt used in the beer-taste beverage of the present invention preferably has a modification of 80% or more. If the modification is less than 80%, viscosity or turbidity of the wort increases, and production efficiencies such as wort filterability and beer filterability deteriorate. Therefore, malt having a modification of 80% or more is preferably used. In Examples and Comparative Examples which will be described below, malt having a modification of 80% or more was used. The modification can be measured by the method described in 3.1.3.8 Modification and Homogeneity (Calcofluor Carlsberg Method-EBC) in MEBAK Raw Materials Barley Adjuncts Malt Hops And Hop Products Published by the Chairman Dr. Fritz Jacob Self-published by MEBAK 85350 Freising-Weihenstephan, Germany 2011.

In the beer-taste beverage according to one embodiment of the present invention, the malt used is preferably selected as appropriate in accordance with the desired chromaticity of the beer-taste beverage, and one kind of malt may be selected, or two or more kinds thereof may be selected in combination.

The malt contains pyroglutamic acid. Therefore, in the present invention, it is preferable to set a ratio of the malt in the raw material within a certain range, so that the pyroglutamic acid of the beer-taste beverage of the present invention falls within the range defined in the present specification. Specifically, the malt ratio (ratio of all malt used) is preferably 50 mass % or more, and may be 51 mass % or more, 52 mass % or more, 53 mass % or more, 54 mass % or more, 55 mass % or more, 56 mass % or more, 57 mass % or more, 58 mass % or more, 59 mass % or more, 60 mass % or more, 61 mass % or more, 62 mass % or more, 63 mass % or more, 64 mass % or more, 65 mass % or more, 66 mass % or more, more than 66 mass %, 66.6 mass % or more, 67 mass % or more, 68 mass % or more, 69 mass % or more, 70 mass % or more, 71 mass % or more, 72 mass % or more, 73 mass % or more, 74 mass % or more, 75 mass % or more, 76 mass % or more, 77 mass % or more, 78 mass % or more, 79 mass % or more, 80 mass % or more, 81 mass % or more, 82 mass % or more, 83 mass % or more, 84 mass % or more, 85 mass % or more, 86 mass % or more, 87 mass % or more, 88 mass % or more, 89 mass % or more, 90 mass % or more, 91 mass % or more, 92 mass % or more, 93 mass % or more, 94 mass % or more, 95 mass % or more, 96 mass % or more, 97 mass % or more, 98 mass % or more, 99 mass % or more, or 100 mass %. By improving the malt ratio, it is possible to produce a beer-taste beverage in which a rich taste derived from malt and an umami taste of barley/wheat can be more strongly perceived.

The malt ratio of the beer-taste beverage of an embodiment according to the present invention may be less than 100 mass % or less, 99 mass % or less, 98 mass % or less, 97 mass % or less, 96 mass % or less, 95 mass % or less, 94 mass % or less, 93 mass % or less, 92 mass % or less, 91 mass % or less, 90 mass % or less, 89 mass % or less, 88 mass % or less, 87 mass % or less, 86 mass % or less, 85 mass % or less, 84 mass % or less, 83 mass % or less, 82 mass % or less, 81 mass % or less, 80 mass % or less, 79 mass % or less, 78 mass % or less, 77 mass % or less, 76 mass % or less, 75 mass % or less, 74 mass % or less, 73 mass % or less, 72 mass % or less, 71 mass % or less, 70 mass % or less, 69 mass % or less, 68 mass % or less, 67 mass % or less, less than 67 mass %, 66.6 mass % or less, 66 mass % or less, 65 mass % or less, 64 mass % or less, 63 mass % or less, 62 mass % or less, 61 mass % or less, or 60 mass % or less, from the viewpoint of providing a beverage which is hard to give unsuitable satiety.

The “malt ratio” herein means a value calculated according to the Interpretation Notice on the Liquor Tax Law and the Administrative Ordinance Related to Alcoholic Beverages and the like enforced on Apr. 1, 2018.

When the malt ratio is suppressed, it is preferable to increase amounts of raw materials (carbon source and nitrogen source), other than malt, which are assimilable by yeast. Examples of the carbon source as the raw material assimilable by yeast include monosaccharides, disaccharides, trisaccharides, sugar solutions thereof, and liquid sugars containing carbon sources. Examples of the nitrogen source as the raw material assimilable by yeast include yeast extract, soybean protein, malt, soybean, yeast extract, pea, wheat malt, ungerminated grains, and decomposition products thereof. Examples of the ungerminated grains include ungerminated barley, wheat, rye, wild oat, oat, adlay, and oat, rice (such as white rice and brown rice), corn, kaoliang, potato, legumes (such as soybeans and peas), buckwheat, sorghum, foxtail millet, and Japanese millet. In addition, starches obtained from these grains and extracts thereof may be used. In an embodiment of the present invention, the malt ratio may be adjusted by using the above-mentioned raw material as an auxiliary raw material.

In this case, a ratio of the auxiliary raw material may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

Further, the ratio of the auxiliary raw material may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The ratio of the auxiliary raw material herein means a value calculated according to the Interpretation Notice on the Liquor Tax Law and the Administrative Ordinance Related to Alcoholic Beverages and the like enforced on Apr. 1, 2018.

In an embodiment of the present invention, corn may be used as the auxiliary raw material to adjust the malt ratio. In this case, a ratio of the corn used as the auxiliary raw material may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

Further, the ratio of the corn may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The ratio of the corn herein means a value calculated according to the Interpretation Notice on the Liquor Tax Law and the Administrative Ordinance Related to Alcoholic Beverages and the like enforced on Apr. 1, 2018.

When corn is used, “corn”, “maize”, or the like is indicated in raw material descriptions.

In an embodiment of the present invention, starch may be used as the auxiliary raw material to adjust the malt ratio. In this case, a ratio of the starch used as the auxiliary raw material may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

The ratio of the starch may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The ratio of the starch herein means a value calculated according to the Interpretation Notice on the Liquor Tax Law and the Administrative Ordinance Related to Alcoholic Beverages and the like enforced on Apr. 1, 2018.

When starch is used, “starch” or the like is indicated in raw material descriptions.

In an embodiment of the present invention, rice may be used as the auxiliary raw material to adjust the malt ratio. In this case, a ratio of the rice used as the auxiliary raw material may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

The ratio of the rice may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The ratio of the rice herein means a value calculated according to the Interpretation Notice on the Liquor Tax Law and the Administrative Ordinance Related to Alcoholic Beverages and the like enforced on Apr. 1, 2018.

When rice is used, “rice” or the like is indicated in raw material descriptions.

In an embodiment of the present invention, liquid sugar may be used as the auxiliary raw material to adjust the malt ratio. In this case, a ratio of the liquid sugar used as the auxiliary raw material may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

The ratio of the liquid sugar may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The ratio of the liquid sugar herein means a value calculated according to the Interpretation Notice on the Liquor Tax Law and the Administrative Ordinance Related to Alcoholic Beverages and the like enforced on Apr. 1, 2018.

When liquid sugar is used, “sugar”, “liquid sugar” or the like is indicated in raw material descriptions.

In an embodiment of the present invention, corn grits may be used as the auxiliary raw material to adjust the malt ratio. In this case, a ratio of the corn grits used as the auxiliary raw material may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

The ratio of the corn grits may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The ratio of the corn grits herein means a value calculated according to the Interpretation Notice on the Liquor Tax Law and the Administrative Ordinance Related to Alcoholic Beverages and the like enforced on Apr. 1, 2018.

When corn grits are used, “corn”, “maize”, “corn grits” or the like is indicated in raw material descriptions.

In addition, when a fermentation raw material other than malt is used as the auxiliary raw material in the beer-taste beverage of an embodiment of the present invention, at least one selected from the group consisting of rice, corn, and starch is preferably used from the viewpoint of imparting a crispy feeling typical of beer-taste beverages. In this case, at least one of rice, corn, and starch has only to be used, two of them may be used in combination, or all three of them may be used.

In an embodiment of the present invention, a total ratio of at least one selected from the group consisting of rice, corn, and starch may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

The total ratio of at least one selected from the group consisting of rice, corn, and starch may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The total ratio of at least one selected from the group consisting of rice, corn, and starch herein means a total value of ratios of rice, corn, and/or starch calculated according to the Interpretation Notice on the Liquor Tax Law and the Administrative Ordinance Related to Alcoholic Beverages and the like enforced on Apr. 1, 2018.

In addition, when a fermentation raw material other than malt is used as the auxiliary raw material in the beer-taste beverage of an embodiment of the present invention, at least one selected from the group consisting of rice, corn, starch, and liquid sugar is preferably used from the viewpoint of imparting a complex taste typical of beer-taste beverages. In this case, at least one of rice, corn, starch, and liquid sugar has only to be used, two of them may be used in combination, three of them may be used in combination, or all four of them may be used.

In an embodiment of the present invention, a total ratio of at least one selected from the group consisting of rice, corn, starch, and liquid sugar may be, for example, 50 mass % or less, and may also be 48 mass % or less, 46 mass % or less, 44 mass % or less, 42 mass % or less, 40 mass % or less, 38 mass % or less, 36 mass % or less, 34 mass % or less, 32 mass % or less, 30 mass % or less, 28 mass % or less, 26 mass % or less, 24 mass % or less, 22 mass % or less, 20 mass % or less, 18 mass % or less, 16 mass % or less, 14 mass % or less, 12 mass % or less, 10 mass % or less, 8 mass % or less, 7 mass % or less, 6 mass % or less, 5 mass % or less, 4 mass % or less, 3 mass % or less, 2 mass % or less, 1 mass % or less, 0.8 mass % or less, 0.6 mass % or less, 0.4 mass % or less, 0.2 mass % or less, 0.1 mass % or less, or 0.01 mass % or less.

The total ratio of at least one selected from the group consisting of rice, corn, starch, and liquid sugar may be, for example, 0.01 mass % or more, and may also be 0.1 mass % or more, 0.2 mass % or more, 0.4 mass % or more, 0.6 mass % or more, 0.8 mass % or more, 1 mass % or more, 2 mass % or more, 3 mass % or more, 4 mass % or more, 5 mass % or more, 6 mass % or more, 7 mass % or more, 8 mass % or more, 9 mass % or more, 10 mass % or more, 12 mass % or more, 14 mass % or more, 16 mass % or more, 18 mass % or more, 20 mass % or more, 22 mass % or more, 24 mass % or more, 26 mass % or more, 28 mass % or more, 30 mass % or more, 32 mass % or more, 34 mass % or more, 36 mass % or more, 38 mass % or more, 40 mass % or more, 42 mass % or more, 44 mass % or more, 46 mass % or more, 48 mass % or more, or 49 mass % or more.

The total ratio of at least one selected from the group consisting of rice, corn, starch, and liquid sugar herein means a total value of ratios of rice, corn, starch, and/or liquid sugar calculated according to the Interpretation Notice on the Liquor Tax Law and the Administrative Ordinance Related to Alcoholic Beverages and the like enforced on Apr. 1, 2018.

Examples of the form of the hops used in an embodiment of the present invention include pellet hops, powdered hops, and hop extract. In addition, the hops used may be a processed hop product, such as isomerized hops or reduced hops.

An amount of the hops added is appropriately adjusted and is preferably from 0.0001 to 1 mass % based on the total amount of the beverage. In addition, a beer-taste beverage made using hops as a raw material is a beverage containing iso-α-acid, which is a component derived from hops.

Examples of the sweetener include saccharides, such as commercially available saccharified liquids produced by degrading starch derived from grain with an acid, an enzyme, or the like, sucrose, and commercially available starch syrup; tri- or higher saccharides; sugar alcohols; isomerized sugars; natural sweeteners, such as stevia; and artificial sweeteners.

These saccharides may be in the form of a liquid, such as a solution, or a solid, such as a powder.

In addition, there are no particular limitations on the type of raw material grain for starch, the method of purifying starch, and the conditions for treatment of hydrolysis with an enzyme or an acid and the like. For example, a saccharide with increased ratio of maltose obtained by appropriately setting conditions for hydrolysis with an enzyme or an acid may be used. In addition, sucrose, fructose, glucose, mannose, arabinose, galactose, xylose, rhamnose, ribose, fucose, lactose, maltose, trehalose, maltotriose, maltotetraose, maltopentaose, isomaltose, isomaltotriose, isomaltotetraose, isomaltopentaose, lactosucrose, 4′-galactosyllactose, 1-kestose, nystose, fructofuranosylnystose, raffinose, stachyose, xylobiose, xylotriose, panose, and solutions (sugar solutions) thereof can also be used. In addition, examples of the artificial sweetener include aspartame, acesulfame potassium (acesulfame K), sucralose, and neotame.

These sweeteners may be used alone, or two or more thereof may be used in combination.

Examples of the water-soluble dietary fiber include indigestible dextrin, polydextrose, guar gum degradation products, pectin, glucomannan, alginic acid, laminarin, fucoidin, and carrageenan. From the viewpoint of versatility, such as stability and safety, indigestible dextrin or polydextrose is preferred.

In the beer-taste beverage, bitterness is preferably imparted by hops or the like, but a bittering agent or a bitterness imparting agent may be further used.

The bittering agent or bitterness imparting agent is not particularly limited, and a substance used as a bitterness imparting agent in ordinary beer and low-malt beer can be used. Examples include rosemary, litchi, amur cork tree, caraway, juniper berry, sage, rosemary, reishi mushroom, bay laurel, reishi mushroom, quassin, citrus extract, bitter wood extract, coffee extract, tea extract, bitter gourd extract, lotus embryo extract, Aloe arborescens extract, rosemary extract, litchi extract, laurel extract, sage extract, caraway extract, wormwood extract, absinthin, and alginic acid.

The antioxidant is not particularly limited, and a substance used as an antioxidant in ordinary beer and low-malt beer can be used, and examples include ascorbic acid, erythorbic acid, and catechin.

As the flavoring, common beer flavorings other than isoamyl alcohol can be used in combination with isoamyl alcohol. The beer flavoring is used for giving a beer-like flavor, and includes, for example, a brewing component generated by fermentation.

The beer-taste beverage contains ethyl acetate produced by alcoholic fermentation, and the ethyl acetate functions as a flavoring. Therefore, when the production process for the beer-taste beverage involves alcoholic fermentation, it is less necessary to separately add a beer flavoring, but a beer flavoring may be added as desired.

Examples of the beer flavoring other than ethyl acetate include esters and higher alcohols, specifically including isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineol, 1,8-cineol, 2,3-diethyl-5-methylpyrazine, γ-decanolactone, γ-undecalactone, ethyl hexanoate, ethyl 2-methylbutyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranyl acetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3(2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, (3-caryophyllene, β-myrcene, furfuryl alcohol, 2-ethylpyrazine, 2,3-dimethylpyrazine, 2-methylbutyl acetate, 5-hydroxymethylfurfural, phenylacetaldehyde, 1-phenyl-3-buten-1-one, trans-2-hexenal, nonanal, and phenethyl alcohol. One of these flavorings may be used alone, or two or more of these flavorings may be used in combination.

The beer-taste beverage according to an embodiment of the present invention has a content of acetaldehyde of 10 mg/L or less. The beer-taste beverage according to an embodiment of the present invention has a content of diacetyl of less than 0.1 ppm by mass.

As the acidulant, those other than the above-mentioned phosphoric acid, citric acid, malic acid, succinic acid, lactic acid, and acetic acid can be further used. Examples of such acidulants include gluconic acid, tartaric acid, phytic acid, glucono-delta-lactone, and salts thereof.

The beer-taste beverage according to an embodiment of the present invention has a content of tartaric acid of 10 mg/L or less.

Examples of a preservative include benzoic acid; benzoate salts, such as sodium benzoate; benzoate esters, such as propyl parahydroxybenzoate and butyl parahydroxybenzoate; and dimethyl dicarbonate. In addition, for the preservative, a commercially available preparation, such as Kyohryoku Sanpurezah (Powerful Sanplezer) (a mixture of sodium benzoate and butyl benzoate, available from San-Ei Gen F.F.I., Inc.) may be used. One of these preservatives may be used alone, or two or more of these preservatives may be used in combination.

The amount of the preservative blended is preferably from 5 to 1200 ppm by mass, more preferably from 10 to 1100 ppm by mass, even more preferably from 15 to 1000 ppm by mass, and still more preferably from 20 to 900 ppm by mass.

Examples of the salt include sodium chloride, potassium acid phosphate, calcium acid phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in combination.

### 1.2 Carbonic Acid Gas

Carbonic acid gas contained in the beer-taste beverage according to one embodiment of the present invention may be carbonic acid gas contained in the raw material, or may be dissolved by mixing with carbonated water, addition of carbonic acid gas, or the like.

Since the beer-taste beverage according to one embodiment of the present invention is produced through alcoholic fermentation, the carbonic acid gas generated in the fermentation step can be used as it is. However, the amount of the carbonic acid gas may be adjusted by appropriately adding carbonated water.

A carbonic acid gas concentration of the beer-taste beverage according to an embodiment of the present invention is preferably 0.30 (w/w) % or more, more preferably 0.35 (w/w) % or more, even more preferably 0.40 (w/w) % or more, still more preferably 0.42 (w/w) % or more, and particularly preferably 0.45 (w/w) % or more, and preferably 0.80 (w/w) % or less, more preferably 0.70 (w/w) % or less, even more preferably 0.60 (w/w) % or less, still more preferably 0.57 (w/w) or less, and particularly preferably 0.55 (w/w) % or less, and may be 0.54 (w/w) % or less, 0.53 (w/w) % or less, 0.52 (w/w) % or less, 0.51 (w/w) % or less, or 0.50 (w/w) % or less.

In the present specification, the carbonic acid gas concentration can be measured by immersing a container containing a target beverage in a water bath at 20° C. for 30 minutes or longer with occasional shaking of the container to adjust the beverage to 20° C. and then using a gas volume measuring device (e.g., such as GVA-500 (available from Kyoto Electronics Manufacturing Co., Ltd.)).

In the case where the beer-taste beverage according to one embodiment of the present invention is a packaged beverage, a carbonic acid gas pressure of the packaged beverage may be appropriately adjusted such that the carbonic acid gas concentration is in the range described above, and is 5.0 kg/cm² or less, 4.5 kg/cm² or less, or 4.0 kg/cm² or less, and 0.20 kg/cm² or more, 0.50 kg/cm² or more, or 1.0 kg/cm² or more. Any of these upper and lower limits may be combined. For example, the carbonic acid gas pressure of the beverage may be 0.20 kg/cm² or more and 5.0 kg/cm² or less, 0.50 kg/cm² or more and 4.5 kg/cm² or less, or 1.0 kg/cm² or more and 4.0 kg/cm² or less.

In the present specification, the gas pressure refers to the gas pressure in the container except in special cases.

The pressure can be measured by a method well-known to those skilled in the art, for example, using a method in which a sample adjusted to 20° C. is fixed to a gas internal pressure meter, the stopcock of the gas internal pressure meter is opened once to release the gas, the stopcock is closed again, the gas internal pressure meter is shaken, and a value when the pointer reaches a certain position is read; or using a commercially available gas pressure measuring device.

### 1.3 Additional Additive

To the beer-taste beverage according to one embodiment of the present invention, various additives may be added as necessary to the extent that the effects of the present invention are not hindered.

Examples of such an additive include colorants; foam-forming agents; fermentation promoters; yeast extract; protein-based substances, such as peptide-containing substances; and seasonings, such as amino acids.

The colorant is used to impart a beer-like color to the beverage, and a caramel dye can be used, for example. The foam-forming agent is used to form beer-like foam in the beverage or to keep the foam of the beverage, and a plant-extracted saponin-based substance, such as soybean saponin or quillaja saponin; a plant protein, such as corn or soybean; and a peptide-containing substance, such as a collagen peptide; a yeast extract; a raw material originating from milk; and/or the like can be appropriately used.

The fermentation promoter is used to promote fermentation by yeast. For example, a yeast extract; a bran component, such as rice or wheat bran; a vitamin; a mineral agent; and/or the like can be used alone or in combination.

### 1.4 Packaged Beverage

The beer-taste beverage according to an embodiment of the present invention may be a packaged beverage packaged in a container. For the packaged beverage, a container of any form and material may be used, and examples of the container include a bottle, a can, a barrel, and a PET bottle. In particular, from the viewpoint of ease of carrying, the container is preferably a can, a bottle, or a PET bottle.

### 2. Method for Producing Beer-Taste Beverage

The present invention also relates to a method for producing a beer-taste beverage. The production method according to an embodiment of the present invention specifically includes adjusting an alcohol content to 1.0 (v/v) % or more and 3.8 (v/v) % or less and a content of pyroglutamic acid to 60 mg/L or more.

The method for producing a beer-taste beverage according to an embodiment of the present invention is not particularly limited, and may be a method for producing a beer-taste beverage through a fermentation step or may be a method for producing a beer-taste beverage without undergoing a fermentation step.

Hereinafter, a method for producing a fermented beer-taste beverage through a fermentation step and a method for producing a non-fermented beer-taste beverage without undergoing a fermentation step will be described.

### 2.1 Method for Producing Fermented Beer-Taste Beverage

Examples of the method for producing a fermented beer-taste beverage according to an embodiment of the present invention include a method including a yeast-based fermentation step. For example, the method may include the following steps (1) to (3).
(1) performing at least one treatment of saccharification treatment, boiling treatment, or solid content removal treatment on a raw material to produce a pre-fermentation liquid;
(2) cooling the pre-fermentation liquid obtained in step (1) to obtain a cooled pre-fermentation liquid; and
(3) adding yeast to the cooled pre-fermentation liquid obtained in step (2) to perform alcoholic fermentation.

In addition to the steps (1) to (3), the production method according to an embodiment of the present invention may include checking and/or adjusting the alcohol content and the pyroglutamic acid content. This step will be described later as step (4). Note that the production method of an embodiment of the present invention does not include a dealcoholization step.

### Step (1)

Step (1) is a step of performing at least one treatment among saccharification treatment, boiling treatment, and solid content removal treatment using various raw materials to obtain a pre-fermentation liquid.

For example, in the case of using malt as a raw material, various raw materials including water and malt are fed in a preparation tank or a preparation tank, and an enzymatic agent, such as a polysaccharide degrading enzyme or a proteolytic enzyme, which promotes a change of a component derived from the raw material may be added as necessary before fermentation.

Examples of the enzymatic agent include amylases, proteases, purine nucleosidases, deaminases, polyphenol oxidases, glucanases, xylanases, pectinases, cellulases, lipases, glucosidases, xanthine oxidases, transglucosidases, glucoamylases, and uricases. These enzymatic agents may be heat-resistant or non-heat-resistant. In addition, the type of enzymatic agent can be properly selected depending on the timing for addition and the step of addition. The enzymatic agents may be used alone, or two or more thereof may be used in combination. In addition, examples include enzymatic agents falling under “(3) Following Enzymatic Agents Added During Brewing Step for Purpose of Rationalization of Brewing and the like” in Article 3 “7.Articles Not Handled as Raw Materials for Alcoholic Beverages” of the Notice on the Liquor Tax Law and the Administrative Ordinance Related to Alcoholic Beverages (revised on Jun. 27, 2018).

Adding these enzymatic agents can efficiently adjust the component composition of the resulting beer-taste beverage. Hops, a preservative, a sweetener, a water-soluble dietary fiber, a bittering agent or bitterness imparting agent, an antioxidant, a flavoring, an acidulant, a salt, and/or the like may be added as various raw materials other than malt. These raw materials may be added before performing the saccharification treatment, during the saccharification treatment, or after completion of the saccharification treatment. In addition, these raw materials may be added during or after the alcoholic fermentation in the next step.

A mixture of the various raw materials is heated to saccharify the starch of the raw materials to perform saccharification treatment. In the present specification, a degree of saccharification in the saccharification treatment is not particularly limited. For example, the starch may be entirely saccharified or partially saccharified.

The temperature and time of the saccharification treatment are preferably appropriately adjusted in view of the type of malt used, the malt ratio, the raw materials other than water and malt, the type and amount of the enzyme used, the original extract concentration of the beverage finally obtained, and the like. For example, in an embodiment of the present invention, the temperature of the saccharification treatment is preferably from 55 to 80° C., and the time of the saccharification treatment is preferably from 1 to 240 minutes, from the viewpoint of adjusting an apparent attenuation of the beer-taste beverage within the above range. In order to further reduce the apparent attenuation, the saccharification treatment is preferably performed at 72 to 85° C. After the saccharification treatment, filtration is performed, and a saccharified liquid is obtained.

The saccharified liquid is preferably subjected to boiling treatment.

When this boiling treatment is performed, hops, a bittering agent, and the like are preferably added in the case of using them as raw materials. Hops, a bittering agent, and/or the like may be added between the start of boiling the saccharified liquid and before the completion of the boiling.

Instead of the saccharified liquid, a pre-fermentation liquid may be prepared by adding hops, a bittering agent, and/or the like to a mixture obtained by adding warm water to a malt extract, and boiling the mixture.

In addition, in the case without using malt, a pre-fermentation liquid may be prepared by mixing, as the raw materials, a liquid sugar containing a carbon source; a nitrogen source as an amino acid-containing raw material other than barley and the like or malt; hops; a preservative; a sweetener; a water-soluble dietary fiber; a bittering agent or a bitterness imparting agent; an antioxidant; a flavoring; an acidulant; a salt; and/or the like together with warm water to prepare a liquid sugar solution, and boiling the liquid sugar solution.

In the case of using hops, it may be added before the boiling treatment or may be added between the start of boiling the liquid sugar solution and before the completion of the boiling.

### Step (2)

Step (2) is a step of cooling the pre-fermentation liquid produced in step (1) to obtain a cooled pre-fermentation liquid.

After the completion of the boiling treatment, the pre-fermentation liquid is transferred to a whirlpool and cooled to from 0 to 23° C. After the cooling, solid contents, such as coagulated protein, may be removed to adjust the original extract concentration.

Through such treatment, a cooled pre-fermentation liquid is obtained.

### Step (3)

Step (3) is a step of adding yeast to the cooled pre-fermentation liquid produced in step (2) to perform alcoholic fermentation.

The yeast used in this step can be appropriately selected in view of the type of the fermented beverage produced, the target flavor, the fermentation conditions, and the like, and top-fermenting yeast may be used, or bottom-fermenting yeast may be used.

The yeast in the form of a yeast suspension as is may be added to raw materials, or a slurry produced by concentrating the yeast by centrifugation or sedimentation may be added to the pre-fermentation liquid. Alternatively, a material obtained by completely removing the supernatant after the centrifugation may be added. The amount of yeast added to a stock solution can be appropriately set and is, for example, appropriately from 5×10⁶ cells/mL to 1×10⁸ cells/mL.

Various conditions, such as the fermentation temperature and the fermentation period, for performing alcoholic fermentation can be appropriately set, and fermentation is preferably performed, for example, under conditions of from 8 to 25° C. for 5 to 10 days, from the viewpoint of adjusting the apparent attenuation. During the fermentation step, the temperature (temperature increase or temperature decrease) or pressure of the fermented liquid may be changed.

The apparent attenuation of the beer-taste beverage can be adjusted by appropriately setting the type, added amount, and timing for addition of a polysaccharide degrading enzyme such as transglucosidase or amylase, or by changing the temperature (increasing or decreasing the temperature) of the fermented liquid or the pressure in the middle of the fermentation step.

In addition, after completion of this step, the yeast may be removed with a filter or the like, and water or an additive, such as a flavoring, an acidulant, or a dye, may be added as necessary.

As described above, the apparent attenuation of the obtained beer-taste beverage can be adjusted to a desired range by appropriately adjusting the conditions for the saccharification treatment in the step (1) and the alcoholic fermentation in the step (3).

### Step (4)

Step (4) is a step of checking and/or adjusting the alcohol content and the pyroglutamic acid content.

The alcohol content and the pyroglutamic acid content can also be adjusted by appropriately setting, for example, the variety of raw material, the blended amount thereof, the preparation conditions (for example, timing for addition of the raw material), the variety of yeast, the fermentation conditions and the like in the steps (1) and (2). Therefore, in the step (4), it is preferable to measure the contents and to confirm whether or not they fall within the above-mentioned ranges. If they fall outside the ranges, it is preferable to perform, for example, adjustment by addition or dilution of an alcohol raw material or a pyroglutamic acid purified product. In this step, the alcohol content and the pyroglutamic acid content are preferably adjusted by dilution by addition of water or carbonated water.

The adjustment of the alcohol content and the pyroglutamic acid content may be performed in parallel with the step (1), the step (2), and/or the step (3), may be performed between the step (1) and the step (2), may be performed between the step (2) and the step (3), or may be performed after the step (3). The alcohol content and the pyroglutamic acid content may be checked at any of the timings described above.

After these steps, a step performed in the production of a beer-taste beverage known to those skilled in the art, such as a step of storing an alcoholic beverage and a filtration step, may be performed.

The beer-taste beverage thus produced is filled in a predetermined container and distributed to the market as a product.

The method of packaging the beer-taste beverage is not particularly limited, and a packaging method known to those skilled in the art can be used. Through the packaging, the beer-taste beverage is filled and sealed in a container. In the packaging, a container of any form and material may be used, and examples of the container are as described above.

### 2.2 Method for Producing Non-Fermented Beer-Taste Beverage

When the fermented beer-taste beverage according to one embodiment of the present invention is a non-fermented beer-taste beverage, it can be produced by a general method for producing a non-fermented beer-taste beverage. Specific examples of the method for producing a non-fermented beer-taste beverage according to one embodiment of the present invention include a method including the following steps (a) to (c):
(a): performing at least one treatment of preparation treatment (mixing treatment of various raw materials), alcohol raw material addition treatment, saccharification treatment, boiling treatment, and solid content removal treatment using various raw materials to obtain a primary raw material liquid;
(b): sterilizing and diluting the primary raw material liquid as necessary, and adding carbonic acid gas by carbonation treatment; and
(c): checking and/or adjusting the alcohol content and the pyroglutamic acid content.

If necessary, the precipitate can be separated and removed by filtration, centrifugation or the like at each stage. In these steps, a normal production process for a soft drink can be used to simply produce a non-fermented beer-taste beverage without using a fermentation facility.

As a specific method for producing the primary raw material liquid by the step (a), the same method as the above-mentioned step (1) is indicated.

In the case of producing a non-fermented alcohol-containing beer-taste beverage, an alcoholic beverage may be added as an alcohol raw material to prepare an alcohol-containing primary raw material liquid. The alcoholic beverage added is not particularly limited, and examples thereof include raw material alcohols, shochu, Awamori, whisky, brandy, and spirits such as vodka, rum, tequila, and gin.

By the carbonation treatment in the step (b), carbonic acid gas is added to the primary raw material liquid or the alcohol-containing primary raw material liquid.

A method for adding carbonic acid gas may be a method in which carbonic acid gas is directly added to the primary raw material liquid or the alcohol-containing primary raw material liquid, or a method in which these raw material liquids are prepared in concentrated states and then carbonic acid gas is added by mixing of the liquids with carbonated water. When carbonic acid gas is added, an additive, such as a preservative, a sweetener, a flavoring, an acidulant, and/or a dye may be added as necessary.

In addition, it is preferable to perform treatment for removing precipitates before the carbonation step in order to remove substances causing lees and miscellaneous tastes.

The sterilization step and the dilution step may be performed before the carbonation treatment, may be performed after the container is filled, or may be performed in both the steps.

Then, as in the step (4), it is preferable to undergo the step of checking and/or adjusting the alcohol content and the pyroglutamic acid content as the step (c).

The step (c) may be carried out between the step (a) and the step (b) or after the step (a) and the step (b). The step (c) may be carried out in parallel with the step (a) and/or the step (b).

The non-fermented beer-taste beverage according to one embodiment of the present invention thus produced is filled in a predetermined container and distributed to the market as a product.

The method of packaging the carbonated beverage is not particularly limited, and a packaging method known to those skilled in the art can be used. Through the packaging, the carbonated beverage of the present invention is filled and sealed in a container. In the packaging, a container of any form and material may be used, and examples of the container are as described above.

### 3. Method for Improving Flavor of Beer-Taste Beverage

The present invention also relates to a method for improving flavor of a beer-taste beverage. The flavor improvement method according to an embodiment of the present invention specifically includes adjusting an alcohol content to 1.0 (v/v) % or more and 3.8 (v/v) % or less and a content of pyroglutamic acid to 60 mg/L or more.

In the present specification, the “flavor” of the beer-taste beverage includes the umami taste of barley/wheat, rich taste derived from barley/wheat, full bodied taste, and taste thickness. In addition, in the present specification, “flavor improvement” or “improving flavor” means that a beverage adjusted so that the alcohol content and the pyroglutamic acid content satisfy the above ranges achieves at least one of: an increase in rich taste derived from barley/wheat, an improvement in full bodied taste, and a suppression in wateriness, as compared with a beverage in which the alcohol content and the pyroglutamic acid content do not satisfy the above ranges.

Methods for adjusting the alcohol content and the pyroglutamic acid content are as described in “1. Beer-taste beverage” and “2. Method for producing beer-taste beverage” above.

### EXAMPLES

Hereinafter, the present invention will be described in more detail by examples and the like, but the present invention is not limited by these examples.

### Examples 1 to 69 and Comparative Examples 1 to 4

Preparation of Beverage

Crushed barley malt was fed in a preparation tank containing 120 L of warm water, then the temperature was raised stepwise and retained, and filtration was performed to remove malt cake and the like. After filtration, the raw material liquid and hops were charged into a boiling pot and adjusted to 100 L with warm water to obtain hot wort.

The obtained hot wort was cooled and aerated with oxygen to obtain 60 L of a pre-fermentation liquid before addition of yeast.

Brewer's yeast (bottom-fermenting yeast) was added to the pre-fermentation liquid thus obtained, and the mixture was fermented for about one week. After a further aging period of about two weeks, the yeast was removed by filtration, and extract-conditioned water was added to prepare a beer-taste beverage.

In each of Examples and Comparative Examples, the amounts and types of raw materials such as malt, liquid sugar, and hops, mashing pattern, type, added amount, and timing for addition of the proteolytic enzyme, set temperature and retention time in each temperature region during wort preparation, pH adjustment, turbidity during wort filtration, hop addition timing, boiling time, fermentation conditions, and the like were set as appropriate to achieve the malt ratios, pyroglutamic acid contents, isoamyl alcohol contents, and alcohol contents listed in Tables 1 to 8. Examples 37 to 69 were prepared by adding acidulants so that the contents of the acidulants were as listed in Tables 6 to 8. The contents of pyroglutamic acid and isoamyl alcohol were adjusted to the values listed in each table by adding pyroglutamic acid and isoamyl alcohol as necessary in addition to setting of the above conditions.

In all Examples and Comparative Examples, the apparent attenuation was 95% or less. Also, in all Examples and Comparative Examples, the carbohydrate content was more than 1.1 g/100 mL and 4.5 g/100 mL or less.

### Sensory Evaluation

The obtained beer-taste beverages were evaluated as follows by the same six panelists tasting each beverage.

Each panelist tasted 350 mL of each beer-taste beverage cooled to about 4° C., and evaluated the evaluation items listed in each table with scores in increments of 0.1 in the range of from 3.0 (maximum) to 1.0 (minimum) based on the following score criteria. The average values of the scores of the six panelists were calculated.

In the evaluation, samples falling in the following criteria “1.0”, “2.0”, or “3.0” for each of the evaluation items were prepared in advance to standardize the criteria among the panelists. Also in sensory evaluation of all Examples and Comparative Examples, for the same beverage, no difference in a score value of 2.0 or more was observed between panelists.

### Full Bodied Taste Suitable for Beer-Taste Beverages

“3.0”: The full bodied taste typical of beer-taste beverages is very strongly perceived.
“2.5”: The full bodied taste typical of beer-taste beverages is strongly perceived.
“2.0”: The full bodied taste typical of beer-taste beverages is perceived.
“1.5”: The full bodied taste typical of beer-taste beverages is not perceived so much.
“1.0”: The full bodied taste typical of beer-taste beverages is hardly perceived.

### Ethanol Feeling Unsuitable for Low Alcohol Beer-Taste Beverages

“3.0”: No ethanol feeling unsuitable for low alcohol beer-taste beverages is perceived at all.
“2.5”: The ethanol feeling unsuitable for low alcohol beer-taste beverages is hardly perceived.
“2.0”: The ethanol feeling unsuitable for low alcohol beer-taste beverages is not perceived so much.
“1.5”: The ethanol feeling unsuitable for low alcohol beer-taste beverages is perceived.
“1.0”: The ethanol feeling unsuitable for low alcohol beer-taste beverages is strongly perceived.

### Aftertaste Suitable for Beer-Taste Beverages

“3.0”: The aftertaste suitable for beer-taste beverages is very strongly perceived.
“2.5”: The aftertaste suitable for beer-taste beverages is strongly perceived.
“2.0”: The aftertaste suitable for beer-taste beverages is perceived.
“1.5”: The aftertaste suitable for beer-taste beverages is not perceived so much.
“1.0”: The aftertaste suitable for beer-taste beverages is hardly perceived.

### [Solvent Odor Unsuitable for Beer-Taste Beverages]

“3.0”: No solvent odor unsuitable for beer-taste beverages is perceived at all.
“2.5”: The solvent odor unsuitable for beer-taste beverages is hardly perceived.
“2.0”: The solvent odor unsuitable for beer-taste beverages is not perceived so much.
“1.5”: The solvent odor unsuitable for beer-taste beverages is perceived.
“1.0”: The solvent odor unsuitable for beer-taste beverages is strongly perceived.

### Refreshing Taste Suitable for Beer-Taste Beverages

“3.0”: The refreshing taste suitable for beer-taste beverages is very strongly perceived.
“2.5”: The refreshing taste suitable for beer-taste beverages is strongly perceived.
“2.0”: The refreshing taste suitable for beer-taste beverages is perceived.
“1.5”: The refreshing taste suitable for beer-taste beverages is not perceived so much.
“1.0”: The refreshing taste suitable for beer-taste beverages is hardly perceived.

### Sourness Unsuitable for Beer-Taste Beverages

“3.0”: No sourness unsuitable for beer-taste beverages is perceived at all.
“2.5”: The sourness unsuitable for beer-taste beverages is hardly perceived.
“2.0”: The sourness unsuitable for beer-taste beverages is not perceived so much.
“1.5”: The sourness unsuitable for beer-taste beverages is perceived.
“1.0”: The sourness unsuitable for beer-taste beverages is strongly perceived.

### Overall Evaluation

“A”: All of the average scores of the verified sensory evaluation items in each table are 2.5 or higher.
“B”: Not falling in “A” or “C”.
“C”: One or more of the average scores of the verified sensory evaluation items in each table is lower than 2.0.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Malt ratio | mass % | 95 | 52 | 95 | 52 | 95 | 64 | 66.6 | 79 |
| Alcohol content | v/v % | 1.1 | 2.3 | 2.3 | 2.9 | 2.9 | 3.2 | 3.2 | 3.2 |
| Pyroglutamic | mg/L | 143 | 102 | 298 | 128 | 376 | 220 | 230 | 280 |
| acid | | | | | | | | | |
| Alcohol content × | | 157 | 234 | 686 | 372 | 1091 | 704 | 736 | 896 |
| pyroglutamic | | | | | | | | | |
| acid content | | | | | | | | | |
| Full bodied taste | | 2.1 | 2.3 | 2.6 | 2.4 | 2.8 | 2.7 | 2.7 | 2.8 |
| suitable for | | | | | | | | | |
| beer-taste | | | | | | | | | |
| beverages | | | | | | | | | |
| Ethanol feeling | | 3.0 | 2.7 | 2.8 | 2.5 | 2.6 | 2.3 | 2.3 | 2.4 |
| unsuitable for | | | | | | | | | |
| low alcohol | | | | | | | | | |
| beer-taste | | | | | | | | | |
| beverages | | | | | | | | | |
| Overall | | B | B | A | B | A | B | B | B |
| evaluation | | | | | | | | | |

| | | Example | Example | Example | Comparative | Comparative | Comparative | Comparative |
|---|---|---|---|---|---|---|---|---|
| | | 9 | 10 | 11 | Example 1 | Example 2 | Example 3 | Example 4 |
| Malt ratio | mass % | 100 | 52 | 95 | 52 | 52 | 52 | 52 |
| Alcohol content | v/v % | 3.4 | 3.5 | 3.5 | 1.1 | 3.9 | 3.9 | 3.9 |
| Pyroglutamic | mg/L | 460 | 155 | 454 | 49 | 128 | 141 | 154 |
| acid | | | | | | | | |
| Alcohol content × | | 1564 | 543 | 1589 | 54 | 499 | 550 | 601 |
| pyroglutamic | | | | | | | | |
| acid content | | | | | | | | |
| Full bodied taste | | 2.9 | 2.5 | 2.9 | 1.8 | 2.5 | 2.5 | 2.6 |
| suitable for | | | | | | | | |
| beer-taste | | | | | | | | |
| beverages | | | | | | | | |
| Ethanol feeling | | 2.3 | 2.1 | 2.2 | 3.0 | 1.8 | 1.9 | 1.9 |
| unsuitable for | | | | | | | | |
| low alcohol | | | | | | | | |
| beer-taste | | | | | | | | |
| beverages | | | | | | | | |
| Overall | | B | B | B | C | C | C | C |
| evaluation | | | | | | | | |

TABLE 2

| | | Example | Example | Example | Example | Example | Example | Example | Example | Example | Example |
|---|---|---|---|---|---|---|---|---|---|---|---|
| | | 12 | 13 | 14 | 15 | 16 | 17 | 18 | 19 | 20 | 21 |
| Malt ratio | wt. % | 64 | 66.6 | 79 | 100 | 55 | 55 | 55 | 95 | 55 | 95 |
| Alcohol content | v/v % | 3.2 | 3.2 | 3.2 | 3.4 | 3.5 | 3.5 | 3.5 | 3.5 | 3.5 | 3.5 |
| Pyroglutamic acid | mg/L | 220 | 230 | 280 | 460 | 169 | 155 | 165 | 454 | 169 | 454 |
| Isoamyl alcohol | mg/L | 55 | 45 | 60 | 102 | 34 | 45 | 66 | 103 | 120 | 120 |
| Alcohol content × | | 704 | 736 | 896 | 1564 | 592 | 543 | 578 | 1589 | 592 | 1589 |
| pyroglutamic acid | | | | | | | | | | | |
| content | | | | | | | | | | | |
| Alcohol content × | | 176 | 144 | 192 | 347 | 120 | 157 | 230 | 359 | 420 | 420 |
| isoamyl alcohol | | | | | | | | | | | |
| content | | | | | | | | | | | |
| Aftertaste suitable | | 2.5 | 2.3 | 2.5 | 2.7 | 2.2 | 2.3 | 2.5 | 2.7 | 2.9 | 2.9 |
| for beer-taste | | | | | | | | | | | |
| beverages | | | | | | | | | | | |
| Solvent odor | | 2.8 | 2.9 | 2.7 | 2.7 | 3.0 | 2.9 | 2.6 | 2.7 | 2.2 | 2.4 |
| unsuitable for | | | | | | | | | | | |
| beer-taste | | | | | | | | | | | |
| beverages | | | | | | | | | | | |
| Overall | | A | B | A | A | B | B | A | A | B | B |
| evaluation | | | | | | | | | | | |

TABLE 3

| | | Example | Example | Example | Example | Example | Example |
|---|---|---|---|---|---|---|---|
| | | 22 | 23 | 24 | 25 | 26 | 27 |
| Malt ratio | wt. % | 55 | 55 | 55 | 95 | 55 | 95 |
| Alcohol content | v/v % | 2.9 | 2.9 | 2.9 | 2.9 | 2.9 | 2.9 |
| Pyroglutamic acid | mg/L | 140 | 128 | 137 | 376 | 140 | 376 |
| Isoamyl alcohol | mg/L | 28 | 37 | 54 | 85 | 120 | 120 |
| Alcohol content × pyroglutamic | | 406 | 372 | 396 | 1091 | 406 | 1091 |
| acid content | | | | | | | |
| Alcohol content × isoamyl | | 82 | 108 | 158 | 247 | 348 | 348 |
| alcohol content | | | | | | | |
| Aftertaste suitable for beer-taste | | 2.1 | 2.2 | 2.4 | 2.6 | 2.9 | 2.9 |
| beverages | | | | | | | |
| Solvent odor unsuitable for beer- | | 3.0 | 3.0 | 2.9 | 2.6 | 2.7 | 2.8 |
| taste beverages | | | | | | | |
| Overall evaluation | | B | B | B | A | A | A |

TABLE 4

| | | Example | Example | Example | Example | Example | Example | Example |
|---|---|---|---|---|---|---|---|---|
| | | 28 | 29 | 30 | 31 | 32 | 33 | 34 |
| Malt ratio | wt. % | 55 | 55 | 95 | 55 | 64 | 66.6 | 79 |
| Alcohol content | v/v % | 2.3 | 2.3 | 2.3 | 2.3 | 2.5 | 2.5 | 2.5 |
| Pyroglutamic acid | mg/L | 102 | 108 | 298 | 102 | 131 | 124 | 164 |
| Isoamyl alcohol | mg/L | 29 | 42 | 69 | 120 | 41 | 32 | 39 |
| Alcohol content × | | 234 | 249 | 686 | 234 | 328 | 310 | 410 |
| pyroglutamic acid content | | | | | | | | |
| Alcohol content × isoamyl | | 66 | 97 | 159 | 276 | 103 | 80 | 98 |
| alcohol content | | | | | | | | |
| Aftertaste suitable for | | 2.1 | 2.3 | 2.5 | 2.9 | 2.3 | 2.2 | 2.3 |
| beer-taste beverages | | | | | | | | |
| Solvent odor unsuitable | | 3.0 | 3.0 | 2.9 | 2.5 | 2.9 | 3.0 | 3.0 |
| for beer-taste beverages | | | | | | | | |
| Overall evaluation | | B | B | A | A | B | B | B |

TABLE 5

| | | Example 35 | Example 36 |
|---|---|---|---|
| Malt ratio | wt. % | 95 | 95 |
| Alcohol content | v/v % | 1.3 | 1.3 |
| Pyroglutamic acid | mg/L | 143 | 143 |
| Isoamyl alcohol | mg/L | 40 | 120 |
| Alcohol content × pyroglutamic acid | | 185 | 185 |
| content | | | |
| Alcohol content × isoamyl alcohol | | 52 | 156 |
| content | | | |
| Aftertaste suitable for beer-taste | | 2.3 | 2.9 |
| beverages | | | |
| Solvent odor unsuitable for beer-taste | | 3.0 | 2.9 |
| beverages | | | |
| Overall evaluation | | B | A |

TABLE 6
Table 6

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple 37 | ple 38 | ple 39 | ple 40 | ple 41 | ple 42 | ple 43 | ple 44 | ple 45 | ple 46 | ple 47 |
| Malt ratio | wt. % | 55 | 55 | 55 | 55 | 55 | 55 | 55 | 55 | 55 | 55 | 55 |
| Alcohol content | v/v % | 3.5 | 3.5 | 3.5 | 3.5 | 3.5 | 3.5 | 3.5 | 3.5 | 3.5 | 3.5 | 3.5 |
| Pyroglutamic acid | mg/L | 165 | 165 | 165 | 165 | 165 | 165 | 165 | 165 | 165 | 165 | 165 |
| Isoamyl alcohol | mg/L | 66 | 66 | 66 | 66 | 66 | 66 | 66 | 66 | 66 | 66 | 66 |
| Phosphoric acid | mg/L | 497 | 700 | 497 | 497 | 497 | 497 | 1000 | 497 | 497 | 497 | 497 |
| Citric acid | mg/L | 202 | 202 | 400 | 202 | 202 | 202 | 202 | 650 | 202 | 202 | 202 |
| Malic acid | mg/L | 109 | 109 | 109 | 300 | 109 | 109 | 109 | 109 | 700 | 109 | 109 |
| Succinic acid | mg/L | 41 | 41 | 41 | 41 | 250 | 41 | 41 | 41 | 41 | 450 | 41 |
| Lactic acid | mg/L | 359 | 359 | 359 | 359 | 359 | 550 | 359 | 359 | 359 | 359 | 920 |
| Acetic acid | mg/L | 60 | 60 | 60 | 60 | 60 | 60 | 60 | 60 | 60 | 60 | 60 |
| Total of acidulants | mg/L | 1268 | 1471 | 1466 | 1459 | 1477 | 1459 | 1771 | 1716 | 1859 | 1677 | 1829 |
| Acidulant/alcohol content | | 362 | 420 | 419 | 417 | 422 | 417 | 506 | 490 | 531 | 479 | 523 |
| Alcohol content × | | 578 | 578 | 578 | 578 | 578 | 578 | 578 | 578 | 578 | 578 | 578 |
| pyroglutamic acid content | | | | | | | | | | | | |
| Alcohol content × | | 230 | 230 | 230 | 230 | 230 | 230 | 230 | 230 | 230 | 230 | 230 |
| isoamyl alcohol content | | | | | | | | | | | | |
| Full bodied taste suitable | | 2.5 | 2.5 | 2.5 | 2.5 | 2.5 | 2.5 | 2.5 | 2.5 | 2.5 | 2.5 | 2.5 |
| for beer-taste beverages | | | | | | | | | | | | |
| Aftertaste suitable for | | 2.5 | 2.5 | 2.5 | 2.5 | 2.5 | 2.5 | 2.5 | 2.5 | 2.5 | 2.5 | 2.5 |
| beer-taste beverages | | | | | | | | | | | | |
| Solvent odor unsuitable | | 2.6 | 2.6 | 2.6 | 2.6 | 2.6 | 2.6 | 2.6 | 2.6 | 2.6 | 2.6 | 2.6 |
| for beer-taste beverages | | | | | | | | | | | | |
| Refreshing taste suitable | | 2.2 | 2.7 | 2.6 | 2.6 | 2.5 | 2.7 | 3.0 | 2.9 | 2.9 | 2.9 | 2.9 |
| for beer-taste beverages | | | | | | | | | | | | |
| Sourness unsuitable for | | 2.9 | 2.8 | 2.7 | 2.7 | 2.7 | 2.8 | 2.3 | 2.2 | 2.2 | 2.2 | 2.2 |
| beer-taste beverages | | | | | | | | | | | | |
| Overall evaluation | | B | A | A | A | A | A | B | B | B | A | B |

TABLE 7
Table 7

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple 48 | ple 49 | ple 50 | ple 51 | ple 52 | ple 53 | ple 54 | ple 55 | ple 56 | ple 57 | ple 58 |
| Malt ratio | wt. % | 64 | 64 | 64 | 64 | 64 | 64 | 64 | 64 | 64 | 64 | 64 |
| Alcohol content | v/v % | 3.2 | 3.2 | 3.2 | 3.2 | 3.2 | 3.2 | 3.2 | 3.2 | 3.2 | 3.2 | 3.2 |
| Pyroglutamic acid | mg/L | 220 | 220 | 220 | 220 | 220 | 220 | 220 | 220 | 220 | 220 | 220 |
| Isoamyl alcohol | mg/L | 55 | 55 | 55 | 55 | 55 | 55 | 55 | 55 | 55 | 55 | 55 |
| Phosphoric acid | mg/L | 451 | 700 | 451 | 451 | 451 | 451 | 1000 | 451 | 451 | 451 | 451 |
| Citric acid | mg/L | 189 | 189 | 400 | 189 | 189 | 189 | 189 | 780 | 189 | 189 | 189 |
| Malic acid | mg/L | 96 | 96 | 96 | 300 | 96 | 96 | 96 | 96 | 695 | 96 | 96 |
| Succinic acid | mg/L | 44 | 44 | 44 | 44 | 250 | 44 | 44 | 44 | 44 | 640 | 44 |
| Lactic acid | mg/L | 260 | 260 | 260 | 260 | 260 | 550 | 260 | 260 | 260 | 260 | 860 |
| Acetic acid | mg/L | 54 | 54 | 54 | 54 | 54 | 54 | 54 | 54 | 54 | 54 | 54 |
| Total of acidulants | mg/L | 1094 | 1343 | 1305 | 1298 | 1300 | 1384 | 1643 | 1685 | 1693 | 1690 | 1694 |
| Acidulant/alcohol content | | 342 | 420 | 408 | 406 | 406 | 433 | 513 | 527 | 529 | 528 | 529 |
| Alcohol content × | | 704 | 704 | 704 | 704 | 704 | 704 | 704 | 704 | 704 | 704 | 704 |
| pyroglutamic acid content | | | | | | | | | | | | |
| Alcohol content × | | 176 | 176 | 176 | 176 | 176 | 176 | 176 | 176 | 176 | 176 | 176 |
| isoamyl alcohol content | | | | | | | | | | | | |
| Full bodied taste suitable | | 2.6 | 2.6 | 2.6 | 2.6 | 2.6 | 2.6 | 2.6 | 2.6 | 2.6 | 2.6 | 2.6 |
| for beer-taste beverages | | | | | | | | | | | | |
| Aftertaste suitable for | | 2.5 | 2.5 | 2.5 | 2.5 | 2.5 | 2.5 | 2.5 | 2.5 | 2.5 | 2.5 | 2.5 |
| beer-taste beverages | | | | | | | | | | | | |
| Solvent odor unsuitable | | 2.8 | 2.8 | 2.8 | 2.8 | 2.8 | 2.8 | 2.8 | 2.8 | 2.8 | 2.8 | 2.8 |
| for beer-taste beverages | | | | | | | | | | | | |
| Refreshing taste suitable | | 2.1 | 2.6 | 2.5 | 2.5 | 2.4 | 2.6 | 2.9 | 2.8 | 2.8 | 2.8 | 2.8 |
| for beer-taste beverages | | | | | | | | | | | | |
| Sourness unsuitable for | | 3.0 | 2.9 | 2.8 | 2.8 | 2.8 | 2.9 | 2.4 | 2.3 | 2.3 | 2.3 | 2.3 |
| beer-taste beverages | | | | | | | | | | | | |
| Overall evaluation | | B | A | A | A | B | A | B | B | B | B | B |

TABLE 8

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple 59 | ple 60 | ple 61 | ple 62 | ple 63 | ple 64 | ple 65 | ple 66 | ple 67 | ple 68 | ple 69 |
| Malt ratio | wt. % | 64 | 64 | 64 | 64 | 64 | 64 | 64 | 64 | 64 | 64 | 64 |
| Alcohol content | v/v % | 2.5 | 2.5 | 2.5 | 2.5 | 2.5 | 2.5 | 2.5 | 2.5 | 2.5 | 2.5 | 2.5 |
| Pyroglutamic acid | mg/L | 131 | 131 | 131 | 131 | 131 | 131 | 131 | 131 | 131 | 131 | 131 |
| Isoamyl alcohol | mg/L | 41 | 41 | 41 | 41 | 41 | 41 | 41 | 41 | 41 | 41 | 41 |
| Phosphoric acid | mg/L | 355 | 500 | 355 | 355 | 355 | 355 | 770 | 355 | 355 | 355 | 355 |
| Citric acid | mg/L | 144 | 144 | 290 | 144 | 144 | 144 | 144 | 560 | 144 | 144 | 144 |
| Malic acid | mg/L | 78 | 78 | 78 | 225 | 78 | 78 | 78 | 78 | 490 | 78 | 78 |
| Succinic acid | mg/L | 29 | 29 | 29 | 29 | 175 | 29 | 29 | 29 | 29 | 440 | 29 |
| Lactic acid | mg/L | 256 | 256 | 256 | 256 | 256 | 405 | 256 | 256 | 256 | 256 | 675 |
| Acetic acid | mg/L | 43 | 43 | 43 | 43 | 43 | 43 | 43 | 43 | 43 | 43 | 43 |
| Total of acidulants | mg/L | 906 | 1051 | 1051 | 1053 | 1051 | 1054 | 1321 | 1321 | 1318 | 1316 | 1324 |
| Acidulant/alcohol content | | 362 | 420 | 421 | 421 | 421 | 422 | 528 | 529 | 527 | 527 | 530 |
| Alcohol content × | | 328 | 328 | 328 | 328 | 328 | 328 | 328 | 328 | 328 | 328 | 328 |
| pyroglutamic acid content | | | | | | | | | | | | |
| Alcohol content × | | 103 | 103 | 103 | 103 | 103 | 103 | 103 | 103 | 103 | 103 | 103 |
| isoamyl alcohol content | | | | | | | | | | | | |
| Full bodied taste suitable | | 2.3 | 2.3 | 2.3 | 2.3 | 2.3 | 2.3 | 2.3 | 2.3 | 2.3 | 2.3 | 2.3 |
| for beer-taste beverages | | | | | | | | | | | | |
| Aftertaste suitable for | | 2.3 | 2.3 | 2.3 | 2.3 | 2.3 | 2.3 | 2.3 | 2.3 | 2.3 | 2.3 | 2.3 |
| beer-taste beverages | | | | | | | | | | | | |
| Solvent odor unsuitable | | 2.9 | 2.9 | 2.9 | 2.9 | 2.9 | 2.9 | 2.9 | 2.9 | 2.9 | 2.9 | 2.9 |
| for beer-taste beverages | | | | | | | | | | | | |
| Refreshing taste suitable | | 2.2 | 2.7 | 2.5 | 2.5 | 2.4 | 2.6 | 2.9 | 2.8 | 2.7 | 2.7 | 2.8 |
| for beer-taste beverages | | | | | | | | | | | | |
| Sourness unsuitable for | | 3.0 | 2.9 | 2.8 | 2.8 | 2.8 | 2.9 | 2.4 | 2.1 | 2.2 | 2.1 | 2.2 |
| beer-taste beverages | | | | | | | | | | | | |
| Overall evaluation | | B | B | B | B | B | B | B | B | B | B | B |

### Preparation of Beverage

Crushed barley malt was fed in a preparation tank containing 120 L of warm water, then transglucosidase was added, the temperature was raised stepwise and retained, and filtration was performed to remove malt cake and the like. After filtration, the raw material liquid and hops were charged into a boiling pot and adjusted to 100 L with warm water to obtain hot wort.

The obtained hot wort was cooled and aerated with oxygen to obtain 60 L of a pre-fermentation liquid before addition of yeast.

Brewer's yeast (top-fermenting yeast) was added to the pre-fermentation liquid thus obtained, and the mixture was fermented for about one week. After a further aging period of about two weeks, the yeast was removed by filtration, and extract-conditioned water was added to prepare a beer-taste beverage.

In each of Examples, the amounts and types of raw materials such as malt and hops, mashing pattern, added amount and timing for addition of transglucosidase, set temperature and retention time in each temperature region during wort preparation, pH adjustment, turbidity during wort filtration, hop addition timing, boiling time, yeast variety, fermentation conditions, and the like were set as appropriate to achieve the alcohol content, pyroglutamic acid content, isoamyl alcohol content, and acidulant contents listed in Table 9. The contents of pyroglutamic acid and isoamyl alcohol were adjusted to the values listed in the table by adding pyroglutamic acid and isoamyl alcohol as necessary in addition to setting of the above conditions.

In all Examples, the apparent attenuation was 95% or less. Also, in all Examples, the carbohydrate content was more than 1.1 g/100 mL and 4.5 g/100 mL or less.

### Sensory Evaluation

The same six panelists tasting each beverage evaluated the obtained beer-taste beverages using the same method and based on the same evaluation criteria as in Examples 1 to 69.

TABLE 9

| | | Example | Example | Example | Example |
|---|---|---|---|---|---|
| | | 70 | 71 | 72 | 73 |
| Malt ratio | wt. % | 100 | 100 | 100 | 100 |
| Alcohol content | v/v % | 2.4 | 2.4 | 3.0 | 2.6 |
| Pyroglutamic acid | mg/L | 120 | 130 | 131 | 127 |
| Isoamyl alcohol | mg/L | 35 | 32 | 36 | 35 |
| Phosphoric acid | mg/L | 369 | 411 | 451 | 410 |
| Citric acid | mg/L | 141 | 168 | 190 | 166 |
| Malic acid | mg/L | 110 | 86 | 130 | 109 |
| Succinic acid | mg/L | 45 | 23 | 50 | 39 |
| Lactic acid | mg/L | 149 | 147 | 180 | 159 |
| Acetic acid | mg/L | 34 | 52 | 68 | 51 |
| Total of | mg/L | 847 | 887 | 1069 | 934 |
| acidulants | | | | | |
| Acidulant/alcohol | | 350 | 370 | 362 | 359 |
| content | | | | | |
| Alcohol content × | | 290 | 312 | 386 | 330 |
| pyroglutamic acid | | | | | |
| content | | | | | |
| Alcohol content × | | 85 | 78 | 107 | 90 |
| isoamyl alcohol | | | | | |
| content | | | | | |
| Full bodied taste | | 2.3 | 2.3 | 2.4 | 2.3 |
| suitable for | | | | | |
| beer-taste | | | | | |
| beverages | | | | | |
| Aftertaste | | 2.2 | 2.2 | 2.2 | 2.2 |
| suitable for | | | | | |
| beer-taste | | | | | |
| beverages | | | | | |
| Solvent odor | | 3.0 | 3.0 | 3.0 | 3.0 |
| unsuitable | | | | | |
| for beer-taste | | | | | |
| beverages | | | | | |
| Refreshing taste | | 2.2 | 2.2 | 2.2 | 2.2 |
| suitable for | | | | | |
| beer-taste | | | | | |
| beverages | | | | | |
| Sourness | | 3.0 | 3.0 | 3.0 | 3.0 |
| unsuitable for | | | | | |
| beer-taste | | | | | |
| beverages | | | | | |
| Overall | | B | B | B | B |
| evaluation | | | | | |

### Examples 74 to 87

### Preparation of Beverage

Crushed barley malt, rice, corn, and starch were fed in a preparation tank containing 120 L of warm water, then the temperature was raised stepwise and retained, and filtration was performed to remove malt cake and the like. After filtration, the raw material liquid and hops were charged into a boiling pot and adjusted to 100 L with warm water to obtain hot wort.

The obtained hot wort was cooled and aerated with oxygen to obtain 60 L of a pre-fermentation liquid before addition of yeast.

Brewer's yeast (bottom-fermenting yeast) was added to the pre-fermentation liquid thus obtained, and the mixture was fermented for about one week. After a further aging period of about two weeks, the yeast was removed by filtration, and extract-conditioned water was added to prepare a beer-taste beverage.

In each of Examples, the amounts and types of raw materials such as malt, hops, rice, corn, and starch, mashing pattern, set temperature and retention time in each temperature region during wort preparation, pH adjustment, turbidity during wort filtration, hop addition timing, boiling time, yeast variety, fermentation conditions, and the like were set as appropriate to achieve the malt ratio, alcohol content, pyroglutamic acid content, isoamyl alcohol content, and acidulant contents listed in Table 10. The contents of pyroglutamic acid and isoamyl alcohol were adjusted to the values listed in the table by adding pyroglutamic acid and isoamyl alcohol as necessary in addition to setting of the above conditions.

In all Examples, the apparent attenuation was 95% or less. Also, in all Examples, the carbohydrate content was more than 1.1 g/100 mL and 4.5 g/100 mL or less.

### Sensory Evaluation

The same six panelists tasting each beverage evaluated the obtained beer-taste beverages using the same method and based on the same evaluation criteria as in Examples 1 to 69.

TABLE 10

| | | Example | Example | Example | Example | Example | Example | Example |
|---|---|---|---|---|---|---|---|---|
| | | 74 | 75 | 76 | 77 | 78 | 79 | 80 |
| Malt ratio | wt. % | 70 | 70 | 70 | 70 | 70 | 70 | 80 |
| Alcohol content | v/v % | 3.8 | 3.8 | 3.0 | 3.0 | 2.4 | 2.4 | 3.8 |
| Pyroglutamic acid | mg/L | 104 | 119 | 83 | 94 | 66 | 76 | 119 |
| Isoamyl alcohol | mg/L | 42 | 39 | 33 | 30 | 26 | 24 | 42 |
| Phosphoric acid | mg/L | 238 | 309 | 188 | 244 | 151 | 195 | 272 |
| Citric acid | mg/L | 131 | 138 | 104 | 109 | 83 | 87 | 150 |
| Malic acid | mg/L | 59 | 63 | 46 | 49 | 37 | 39 | 67 |
| Succinic acid | mg/L | 41 | 44 | 32 | 34 | 26 | 27 | 47 |
| Lactic acid | mg/L | 103 | 93 | 81 | 73 | 65 | 58 | 103 |
| Acetic acid | mg/L | 64 | 77 | 51 | 61 | 40 | 48 | 64 |
| Total of acidulants | mg/L | 636 | 724 | 502 | 570 | 402 | 454 | 703 |
| Acidulant/alcohol content | | 170 | 192 | 166 | 189 | 165 | 188 | 187 |
| Alcohol content × pyroglutamic acid content | | 390 | 449 | 249 | 283 | 161 | 183 | 447 |
| Alcohol content × isoamyl alcohol content | | 158 | 146 | 100 | 90 | 63 | 58 | 158 |
| Full bodied taste suitable for beer-taste beverages | | 2.4 | 2.4 | 2.2 | 2.3 | 2.2 | 2.2 | 2.4 |
| Aftertaste suitable for beer-taste beverages | | 2.3 | 2.3 | 2.3 | 2.2 | 2.2 | 2.2 | 2.3 |
| Solvent odor unsuitable for beer-taste beverages | | 2.9 | 2.9 | 3.0 | 3.0 | 3.0 | 3.0 | 3.0 |
| Refreshing taste suitable for beer-taste beverages | | 2.1 | 2.1 | 2.1 | 2.1 | 2.1 | 2.1 | 2.1 |
| Sourness unsuitable for beer-taste beverages | | 3.0 | 3.0 | 3.0 | 3.0 | 3.0 | 3.0 | 3.0 |
| Overall evaluation | | B | B | B | B | B | B | B |

| | | Example | Example | Example | Example | Example | Example | Example |
|---|---|---|---|---|---|---|---|---|
| | | 81 | 82 | 83 | 84 | 85 | 86 | 87 |
| Malt ratio | wt. % | 90 | 80 | 90 | 80 | 90 | 51 | 51 |
| Alcohol content | v/v % | 3.8 | 3.0 | 3.0 | 2.4 | 2.4 | 3.8 | 3.0 |
| Pyroglutamic acid | mg/L | 153 | 95 | 93 | 78 | 97 | 76 | 61 |
| Isoamyl alcohol | mg/L | 39 | 33 | 31 | 27 | 25 | 42 | 33 |
| Phosphoric acid | mg/L | 400 | 159 | 241 | 172 | 255 | 175 | 137 |
| Citric acid | mg/L | 180 | 88 | 108 | 95 | 112 | 97 | 76 |
| Malic acid | mg/L | 82 | 39 | 50 | 42 | 52 | 44 | 34 |
| Succinic acid | mg/L | 57 | 28 | 39 | 30 | 36 | 30 | 24 |
| Lactic acid | mg/L | 93 | 82 | 77 | 65 | 59 | 104 | 82 |
| Acetic acid | mg/L | 77 | 51 | 62 | 40 | 49 | 64 | 53 |
| Total of acidulants | mg/L | 889 | 447 | 577 | 444 | 563 | 514 | 406 |
| Acidulant/alcohol content | | 236 | 148 | 190 | 184 | 234 | 135 | 136 |
| Alcohol content × pyroglutamic acid content | | 575 | 287 | 282 | 188 | 234 | 289 | 182 |
| Alcohol content × isoamyl alcohol content | | 146 | 100 | 93 | 66 | 61 | 160 | 99 |
| Full bodied taste suitable for beer-taste beverages | | 2.5 | 2.3 | 2.2 | 2.2 | 2.2 | 2.3 | 2.2 |
| Aftertaste suitable for beer-taste beverages | | 2.3 | 2.3 | 2.2 | 2.2 | 2.2 | 2.3 | 2.3 |
| Solvent odor unsuitable for beer-taste beverages | | 2.9 | 3.0 | 3.0 | 3.0 | 3.0 | 2.9 | 3.0 |
| Refreshing taste suitable for beer-taste beverages | | 2.1 | 2.1 | 2.1 | 2.1 | 2.1 | 2.1 | 2.1 |
| Sourness unsuitable for beer-taste beverages | | 3.0 | 3.0 | 3.0 | 3.0 | 3.0 | 3.0 | 3.0 |
| Overall evaluation | | B | B | B | B | B | B | B |

From the results of Table 1, it was found that the beer-taste beverages having an alcohol content of 1.0 (v/v) % or more and 3.8 (v/v) % or less and a content of pyroglutamic acid of 60 mg/L or more had a good full bodied taste and provided a reduced ethanol feeling. In addition, from the results of Tables 2 to 5, the beer-taste beverages having an alcohol content and a pyroglutamic acid content falling within the above-described ranges and a content of isoamyl alcohol of from 20 to 180 mg/L had good aftertaste and a reduced solvent odor. Furthermore, from the results of Tables 6 to 10, the beer-taste beverages having an alcohol content, a pyroglutamic acid content, and an isoamyl alcohol content falling within the above-described ranges and containing the specific acidulants in predetermined amounts had a good refreshing taste and a reduced unsuitable sourness in addition to the above-described characteristics.

1. A beer-taste beverage having:
an alcohol content of 1.0 (v/v) % or more and 3.8 (v/v) % or less, and
a content of pyroglutamic acid of 60 mg/L or more.

2. The beer-taste beverage according to claim 1, wherein a malt ratio is 50 mass % or more.

3. The beer-taste beverage according to claim 1, wherein an apparent attenuation is less than 100%.

4. The beer-taste beverage according to claim 1, wherein a content of isoamyl alcohol is more than 20 mg/L and 190 mg/L or less.

5. The beer-taste beverage according to claim 1, further comprising at least one acidulant selected from the group consisting of phosphoric acid, citric acid, malic acid, succinic acid, lactic acid, and acetic acid.

6. The beer-taste beverage according to claim 5, wherein a ratio [(B)/(A)] of a content (B) (unit: mg/L) of the acidulant to the alcohol content (A) (unit: v/v %) is 550 or less.

7. The beer-taste beverage according to claim 5, wherein the content (B) of the acidulant is from 500 to 2000 mg/L.

8. The beer-taste beverage according to claim 5, wherein the content of the at least one acidulant selected from the group consisting of phosphoric acid, citric acid, malic acid, succinic acid, lactic acid, and acetic acid satisfies at least one of the following:
a content of phosphoric acid: from 300 to 1200 mg/L;
a content of citric acid: from 100 to 900 mg/L;
a content of malic acid: from 40 to 800 mg/L;
a content of succinic acid: from 10 to 700 mg/L,
a content of lactic acid: from 100 to 1000 mg/L; and
a content of acetic acid: from 10 to 100 mg/L.

9. The beer-taste beverage according to claim 1, wherein the alcohol content is 1.5 (v/v) % or more and 3.3 (v/v) % or less.

10. The beer-taste beverage according to claim 1, wherein a carbohydrate content is 1.0 g/100 mL or more.

11. The beer-taste beverage according to claim 1, wherein the carbohydrate content is 2.0 g/100 mL or more.

12. A method for producing a beer-taste beverage, the method comprising adjusting
an alcohol content to 1.0 (v/v) % or more and 3.8 (v/v) % or less and
a content of pyroglutamic acid to 60 mg/L or more.

13. A method for improving flavor of a beer-taste beverage, the method comprising adjusting
an alcohol content to 1.0 (v/v) % or more and 3.8 (v/v) % or less and
a content of pyroglutamic acid to 60 mg/L or more.
